(19) United States
(12) Patent Application Publication
(10) Pub. No.: US 2025/0265803 A1
(43) Pub. Date: Aug. 21, 2025

(54) MULTI-SENSOR COORDINATION METHOD, PROCESSING DEVICE, AND INFORMATION DISPLAY SYSTEM

(71) Applicant: Industrial Technology Research Institute, Hsinchu (TW)

(72) Inventors: Jian-Lung Chen, Taoyuan City (TW); Ting-Hsun Cheng, Chiayi County (TW); Yu-Ju Chao, Hsinchu County (TW); Chih-Chia Chang, Nantou County (TW); Yu-Hsin Lin, Miaoli County (TW)

(73) Assignee: Industrial Technology Research Institute, Hsinchu (TW)

(21) Appl. No.: 18/739,269

(22) Filed: Jun. 10, 2024

(30) Foreign Application Priority Data
Feb. 21, 2024 (TW) 113106215

(51) Int. Cl. G06V 10/25; G06T 5/80; G06T 7/70; G06V 10/10; G06V 10/764

(52) U.S. Cl. CPC G06V 10/25; G06T 5/80; G06T 7/70; G06V 10/16; G06V 10/764; G06T 2207/20084; G06T 2207/30201; G06V 2201/07

(57) ABSTRACT

A multi-sensor coordination method, a processing device, and an information display system are proposed. The multi-sensor coordination method is adapted to the information display system including a display and multiple image sensors, and includes the following steps. A plurality of images respectively captured by the image sensors are obtained. An object recognition processing is performed on the images or a stitching image of the images to obtain a plurality of object information of a real scene object. A fusion weight of each image sensor is determined. An information fusion processing is performed on the object information according to the fusion weight of each image sensor to obtain object fusion information of the real scene object. Display content of the display is determined based on the object fusion information.

### CROSS-REFERENCE TO RELATED APPLICATION

This application claims the priority benefit of Taiwan application serial no. 113106215, filed on Feb. 21, 2024. The entirety of each of the above-mentioned patent applications is hereby incorporated by reference herein.

### BACKGROUND

### Technical Field

This disclosure relates to an information sensing technology.

### Description of Related Art

With the development of image processing technology and spatial positioning technology, the application of transparent display has gradually attracted attention. This type of technology allows the display provide virtual information match with the real scene object, and may generate interactive experiences according to the user's needs, enabling information to be presented in a more intuitive way. An image sensor is a sensing device that may be configured to obtain position information of users or real scene object.

However, the sensing field of view of a single image sensor is limited. For a wide application field, the photographed object may be obscured or not within the sensing field of view of the image sensor. The sensing range may be expanded by installing multiple image sensors. However, if a simple filtering operation is performed on the repetitive information in the overlapping sensing fields of multiple image sensors, it may result in the display position of the information being determined alternately based on the sensing results of different image sensors. As a result, more flickering of the displayed information may occur, making it difficult for users to read.

### SUMMARY

In an exemplary embodiment of the disclosure, a multi-sensor coordination method is adapted to an information display system including a display and a plurality of image sensors, and includes the following steps. A plurality of images captured by the image sensors are obtained. An object recognition processing is performed on the images or a stitching image of the images to obtain a plurality of object information of a real scene object. A fusion weight of each of the image sensors is determined. An information fusion processing is performed on the plurality of object information according to the fusion weight of each of the image sensors to obtain an object fusion information of the real scene object. Display content of a display is determined according to the object fusion information.

In an exemplary embodiment of the disclosure, an information display system includes a display, a plurality of image sensors and a processing apparatus. The processing apparatus is connected to the display and the image sensors. The processing apparatus is configured to perform the following operations. A plurality of images captured by the image sensors are obtained. An object recognition processing is performed on the images or a stitching image of the images to obtain a plurality of object information of a real scene object. A fusion weight of each of the image sensors is determined. An information fusion processing is performed on the plurality of object information according to the fusion weight of each of the image sensors to obtain an object fusion information of the real scene object. Display content of a display is determined according to the object fusion information.

In an exemplary embodiment of the disclosure, a processing apparatus includes a memory and a processor connected to the memory. The memory is configured to store data, and the processor is configured to perform the following operations. A plurality of images captured by a plurality of image sensors are obtained. An object recognition processing is performed on the images or a stitching image of the images to obtain a plurality of object information of a real scene object. A fusion weight of each of the image sensors is determined. An information fusion processing is performed on the plurality of object information according to the fusion weight of each of the image sensors to obtain an object fusion information of the real scene object. Display content of a display is determined according to the object fusion information.

### BRIEF DESCRIPTION OF THE DRAWINGS

The accompanying drawings are included to provide further understanding, and are incorporated in and constitute a part of the specification. The drawings illustrate exemplary embodiments and, together with the description, serve to explain the principles of the disclosure.

FIG. 1A is a block diagram of an information display system according to an exemplary embodiment of the disclosure.

FIG. 1B is a schematic diagram of an information display system according to an exemplary embodiment of the disclosure.

FIG. 1C is a schematic diagram of an information display system according to an exemplary embodiment of the disclosure.

FIG. 2 is a flowchart of a multi-sensor coordination method according to an exemplary embodiment of the disclosure.

FIG. 3 is a flowchart of generating a stitching image according to an exemplary embodiment of the disclosure.

FIG. 4A and FIG. 4B are schematic diagrams of generating a stitching image according to an exemplary embodiment of the disclosure.

FIG. 5 is a flowchart of a multi-sensor coordination method according to an exemplary embodiment of the disclosure.

FIG. 6A is a schematic diagram of generating spatial coordinates associated with a plurality of images according to an exemplary embodiment of the disclosure.

FIG. 6B is a schematic diagram illustrating calculation of area intersection information and generation of fusion spatial coordinates according to an exemplary embodiment of the disclosure.

FIG. 7 is a flowchart of a multi-sensor coordination method according to an exemplary embodiment of the disclosure.

FIG. 8 is a schematic diagram of obtaining multiple fusion classification confidence values according to an exemplary embodiment of the disclosure.

FIG. 9 is a flowchart of a multi-sensor coordination method according to an exemplary embodiment of the disclosure.

FIG. 10 is a flowchart of determining fusion weights according to an exemplary embodiment of the disclosure.

FIG. 11A and FIG. 11B are schematic diagrams of determining fusion weights according to an exemplary embodiment of the disclosure.

FIG. 12 is a schematic diagram of obtaining the fusion facial orientation angle and fusion spatial coordinates according to an exemplary embodiment of the disclosure.

FIG. 13 is a schematic diagram of improving information jitter according to an exemplary embodiment of the disclosure.

FIG. 14A and FIG. 14B are schematic diagrams of improving information jitter according to an exemplary embodiment of the disclosure.

FIG. 15 is a schematic diagram of determining fusion weights according to an exemplary embodiment of the disclosure.

FIG. 16 is a flowchart of a multi-sensor coordination method according to an exemplary embodiment of the disclosure.

FIG. 17 is a schematic diagram of obtaining finger bending information according to an exemplary embodiment of the disclosure.

FIG. 18 is a schematic diagram of determining target control gesture according to an exemplary embodiment of the disclosure.

FIG. 19 is a schematic diagram of adjusting the fusion finger bending information according to the variation amount according to an exemplary embodiment of the disclosure.

FIG. 20 is a flowchart of a multi-sensor coordination method according to an exemplary embodiment of the disclosure.

FIG. 21 is a schematic diagram of a multi-sensor coordination method according to an exemplary embodiment of the disclosure.

### DESCRIPTION OF THE EMBODIMENTS

Some exemplary embodiments of the disclosure may be described below with reference to the accompanying drawings. The component symbols cited in the following description may be regarded as the same or similar components when the same component symbols appear in different drawings. These exemplary embodiments are only part of the disclosure and do not disclose all possible implementations of the disclosure. Rather, these exemplary embodiments are only examples of methods, devices, and systems within the scope of the patent application of the disclosure.

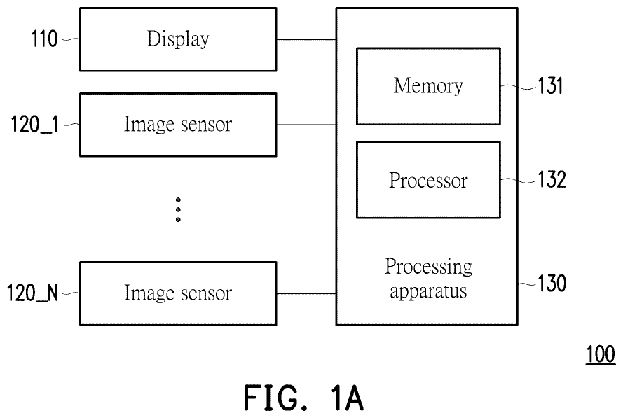

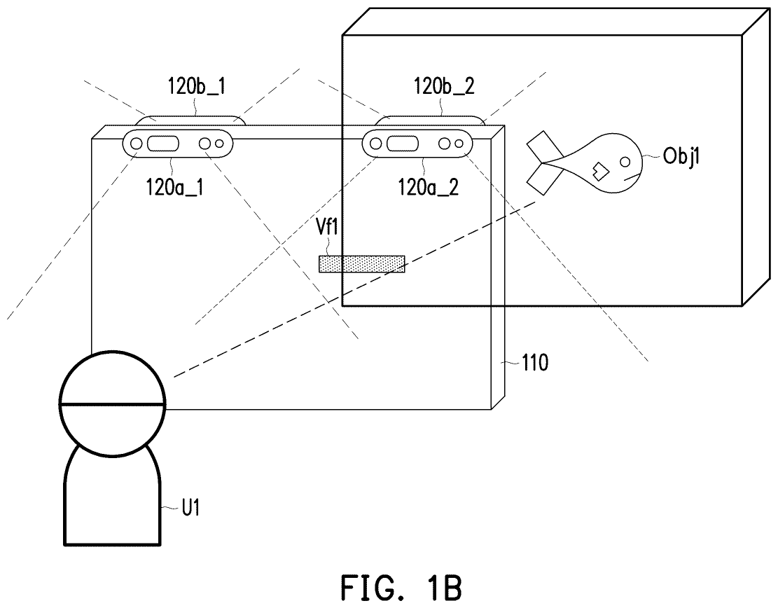

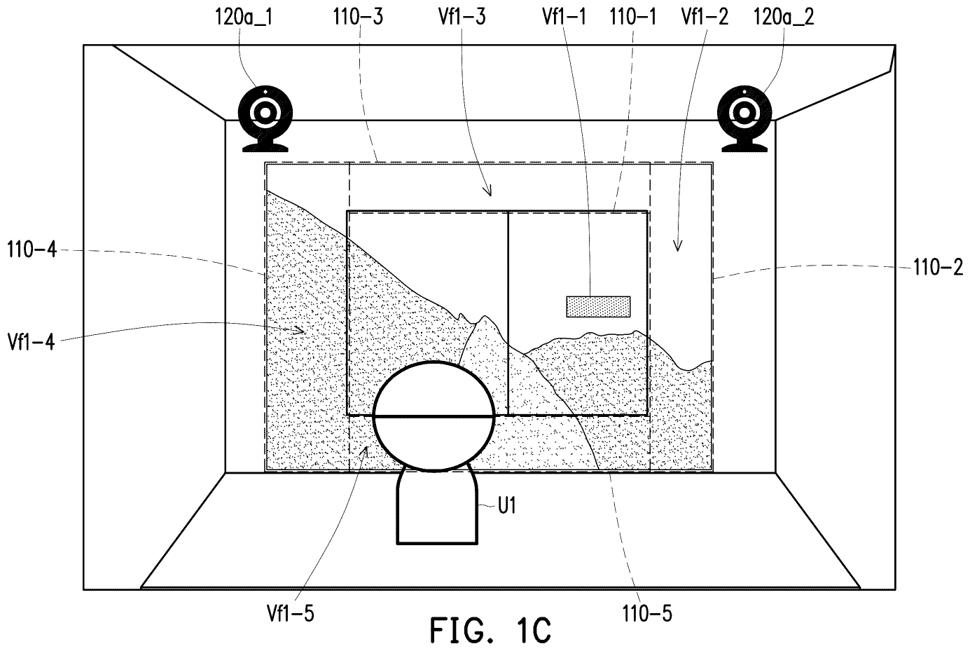

FIG. 1A is a block diagram of an information display system according to an exemplary embodiment of the disclosure. Referring to FIG. 1, the information display system 100 may include a display 110, a plurality of image sensors 120_1 to 120_N, and a processing apparatus 130. The processing apparatus 130 may be wirelessly, wired or electrically connected to the display 110 and the plurality of image sensors 120_1 to 120_N.

The display 110 may be configured to display information, including, for example, a liquid crystal display (Liquid crystal display, LCD), a field sequential color (Field sequential color) liquid crystal display, a light emitting diode (Light emitting diode, LED) display, and an organic light emitting diode. (Organic Light emitting diode, OLED) display, electrowetting display and other displays or projection displays, this disclosure is not limited thereto. In different embodiments, the display 110 may be a light-transmissive display or an opaque display, and the disclosure is not limited thereto.

A plurality of image sensors 120_1 to 120_N are configured to generate sensing information. This disclosure does not limit the number of multiple image sensors 120_1 to 120_N, which may be 2, 3 or other numbers. Each image sensor 120_1 to 120_N may include a camera module having a lens and a photosensitive element. In different embodiments, the image sensors 120_1 to 120_N may be infrared light sensors or visible light sensors. In other words, the image in the embodiments of the disclosure may be a color image or an infrared image.

The processing apparatus 130 is configured to control the operation of the information display system 100, and may include a memory 131 and a processor 132. Memory 131 may be, for example, any type of fixed or removable random access memory (RAM), read-only memory (ROM), flash memory (flash memory), hard disk or other Similar devices, integrated circuits or combinations thereof. The processor 132 may be, for example, a central processing unit (CPU), an application processor (AP), or other programmable general-purpose or special-purpose microprocessor (microprocessor) or digital signal processor (digital signal). processor (DSP), image signal processor (image signal processor, ISP), graphics processor (graphics processing unit, GPU) or other similar devices, integrated circuits or combinations thereof.

In an embodiment of disclosure, the plurality of image sensors 120_1 to 120_N may capture images toward the front and/or the rear of the display 110. In some embodiments, the image sensors 120_1 to 120_N may capture user images in the real scene in front of the display device 110. In some embodiments, the image sensors 120_1 to 120_N may capture images of target objects in the real scene behind the display device 110. Based on the images generated by the image sensors 120_1 to 120_N, the processing apparatus 130 may obtain the user's position information and/or posture information (such as line of sight or gesture, etc.). Alternatively, the processing apparatus 130 may obtain the position information of the target object based on the images generated by multiple image sensors 120_1 to 120_N.

In some embodiments, the processing apparatus 130 may determine the display content of the display 110 based on the user's position information and/or posture information. In some embodiments, the processing apparatus 130 may determine the display content of the display 110 based on the position information of the target object. In some embodiments, the processing apparatus 130 may determine the display content of the display 110 based on the position information/posture information of the target and the user at the same time.

For example, FIG. 1B is a schematic diagram of an information display system according to an exemplary embodiment of the disclosure. Referring to FIG. 1B, the display 110 may be a light-transmissive display. The user U1 and the target Obj1 are located on different sides of the display 110 respectively. Since the display 110 is a light-transmissive display, the user U1 may view the real scene with the display information Vf1 of the target object Obj1 through the display 110. The display information Vf1 may be regarded as augmented reality content augmented based on the target object Obj1.

As shown in FIG. 1B, the image sensors 120a_1 to 120a_2 may capture images including the user U1 toward the real scene in front of the display 110, and the image sensors 120b_1 to 120b_2 may capture images including the target Obj1 toward the real scene behind the display 110. That is to say, the images captured by the image sensors 120a_1 to 120a_2 may be configured to determine the position information and/or posture information of the user U1. The images captured by the image sensors 120b_1 to 120b_2 may be configured to determine the position information of the target Obj1. The processing apparatus 130 may determine the display content of the display 110 based on the position information and/or posture information of the user U1 and the position information of the target Obj1, such as the display position or information content of the display information Vf1, and so on.

It should be noted that, compared with using only a single image sensor, the deployment of image sensors 120a_1 to 120a_2 and image sensors 120b_1 to 120b_2 may expand the sensing range. The sensing fields of view of image sensors 120a_1 to 120a_2 may overlap, and the sensing fields of view of image sensors 120b_1 to 120b_2 may also overlap. The user U1 may be sensed by the image sensors 120a_1 to 120a_2 at the same time. The target Obj1 may also be sensed by the image sensors 120b_1 to 120b_2 at the same time. In the embodiment of the disclosure, the processing apparatus 130 may perform information fusion processing on the object information generated based on different image sensors 120a_1 to 120a_2, so as to determine the position information and/or posture information of the user U1 based on the information fusion result. Similarly, the processing apparatus 130 may perform information fusion processing on the object information generated based on different image sensors 120b_1 to 120a_2, so as to determine the position information of the target object Obj1 based on the information fusion result. It should be noted that, FIG. 1B takes two image sensors with overlapping sensing fields as an example, but the disclosure is not limited thereto.

For example, FIG. 1C is a schematic diagram of an information display system according to an exemplary embodiment of the disclosure. Referring to FIG. 1C, the display 110-1 located in the center may be configured as a light-transmissive display for use as a window screen, for example. The displays 110-2 to 110-5 surrounding the display 110-1 may be light-tight displays installed on the wall. Since the display 110-1 is a light-transmissive display, the user U1 may view the real scene with the display information Vf1-1 through the display 110-1. In addition, user U1 may also see the display contents of display 110-2˜110-5. In this example, displays 110-2 to 110-5 may be configured to extend the display of the scenery outside the window, that is, the display screens Vf1-2 to Vf1-5 of displays 110-2 to 110-5 are extended screens of the real scene.

As shown in FIG. 1C, image sensors 120a_1 to 120a_2 capture images including user U1 in front of the display 110-2 to 110-5. That is to say, the images captured by the image sensors 120a_1 to 120a_2 may be configured to determine the position information and/or posture information of the user U1. The processing apparatus 130 may determine the display content of the displays 110-1 to 110-5 based on the position information and/or posture information of the user U1, wherein the determined display content is the display screens Vf1-1 to Vf1-5 of the displays 110-1 to 110-5. It may be seen that the sensing fields of image sensors 120a_1 to 120a_2 may overlap. The user U1 may be sensed by the image sensors 120a_1 to 120a_2 at the same time. In an embodiment of disclosure, the processing apparatus 130 may perform information fusion processing on the object information generated based on different image sensors 120a_1 and 120a_2, so as to determine the position information and/or posture information of the user U1 based on the information fusion result. In other words, the display frames Vf1-1 to Vf1-5 are determined based on the information fusion results of different image sensors 120a_1 to 120a_2. It should be noted that, FIG. 1C merely takes two image sensors with overlapping sensing fields as an example, but the disclosure is not limited thereto.

In the following example embodiment, each component of the information display system 100 may be configured to illustrate the multi-sensor coordination method process performed by the processing apparatus 130.

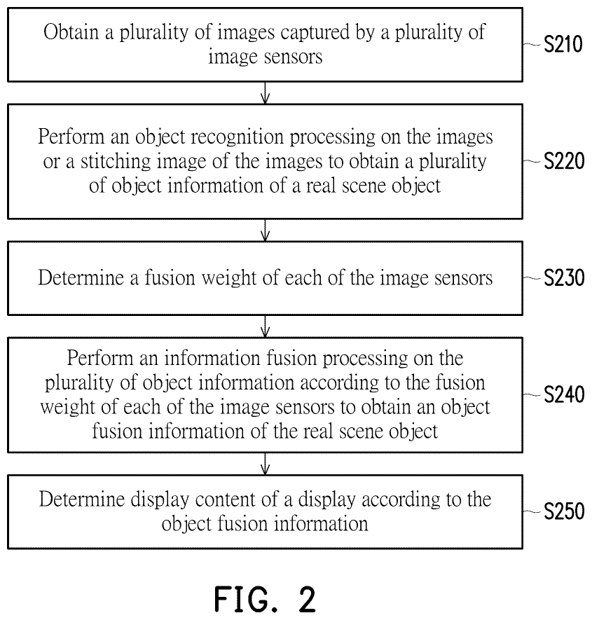

FIG. 2 is a flow chart of a multi-sensor coordination method according to an exemplary embodiment of the disclosure. Referring to FIG. 1A and FIG. 2 simultaneously, the method of FIG. 2 may be implemented by the information display system 100 of FIG. 1A.

In step S210, the processing apparatus 130 may obtain the images captured by the image sensors 120_1 to 120_N. According to the installation positions of these image sensors 120_1 to 120_N, the image sensors 120_1 to 120_N may respectively have different sensing field of view ranges. It should be noted that, the sensing fields of view of these image sensors 120_1 to 120_N may partially overlap with each other. As shown in FIG. 1B, the sensing fields of view of image sensors 120a_1 and 120a_2 may partially overlap with each other.

In step S220, the processing apparatus 130 may perform an object recognition processing on the image or the stitching image of the images, and may obtain multiple a plurality of object information of a real scene object (such as the target object Obj1 or the user U1 shown in FIG. 1B).

In some embodiments, the processing apparatus 130 may perform the object recognition processing on the image respectively, and obtain a plurality of object information of the real scene object according to the image. For example, the processing apparatus 130 may obtain object information of the real scene object based on the image of the image sensor 120_1. The processing apparatus 130 may obtain other object information of the real scene object based on the image of the image sensor 120_2.

In some embodiments, the processing apparatus 130 may first perform a stitching processing on the image to generate a stitching image. Afterwards, the processing apparatus 130 may perform the object recognition processing on the stitching image to obtain a plurality of object information of the real scene object. It should be noted that, if a certain real scene object is far away from the image sensors 120_1 to 120_N, the stitching image may contain multiple image objects of the same real scene object. In this case, the processing apparatus 130 may perform the object recognition processing on the stitching image to obtain a plurality of object information of the same real scene object.

In different embodiments, the object recognition processing may be implemented based on different image object recognition technologies. In some embodiments, the object recognition process may include using a convolutional neural network model (CNN model) to detect and recognize image objects in the image. In some embodiments, the object recognition process may include face recognition technology to detect and identify face objects in the image. In some embodiments, the object recognition process may include hand recognition technology to detect and identify human hand objects in the image.

In step S230, the processing apparatus 130 may determine a fusion weight of each of the image sensors 120_1˜120_N. Before performing information fusion on the object information generated based on different image sensors 120_1 to 120_N, the processing apparatus 130 may determine the fusion weight corresponding to each image sensor 120_1 to 120_N. In some embodiments, the processing apparatus 130 may also determine the fusion weight of each image sensor 120_1 to 120_N based on the device information (such as resolution or installation location, etc.) of each image sensor 120_1 to 120_N. Alternatively, in some embodiments, the processing apparatus 130 may determine the fusion weight of each image sensor 120_1 to 120_N based on the object recognition results of each image. For example, the processing apparatus 130 may determine the fusion weight of each image sensor 120_1 to 120_N based on the positions of different image objects of the same real scene object in different images. Alternatively, the processing apparatus 130 may also determine the fusion weight of each image sensor 120_1 to 120_N based on the object detection rate of each image sensor 120_1 to 120_N. Subsequent embodiments may be described in more detail.

In step S240, the processing apparatus 130 may perform information fusion processing on the plurality of object information according to the fusion weights of each of the image sensors 120_1 to 120_N, to obtain object fusion information of the real scene object. In some embodiments, the object information may be, for example, a plurality of spatial coordinates, a plurality of posture angles (such as facial orientation angles), a plurality of posture evaluation quantified values, or other object information that has been quantized into values. Based on this, the processing apparatus 130 may perform a weighted operation based on the fusion weight of each image sensor 120_1 to 120_N and the plurality of object information to obtain object fusion information of the real scene object.

In step S250, the processing apparatus 130 may determine display content of the display 110 based on the object fusion information. That is to say, the display content of the display 110 is determined by considering the sensing results of the image sensors 120_1 to 120_N. The display content of display 110 may not jitter significantly due to a malfunction of an image sensor or obstruction of the field of view, greatly improving the comfort of viewing the display content.

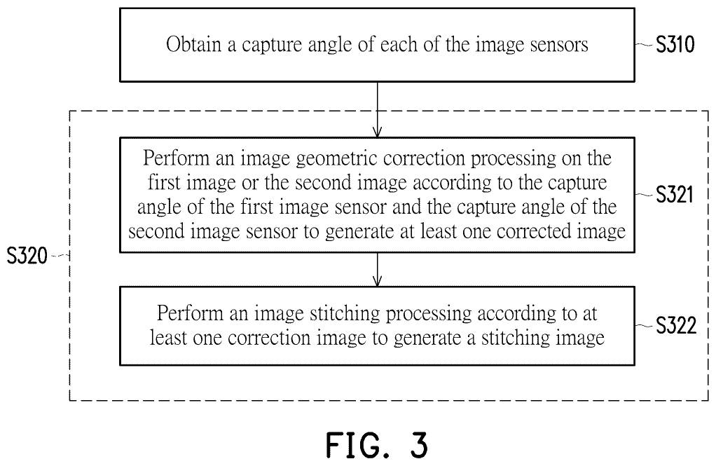

FIG. 3 is a flowchart of generating a stitching image according to an exemplary embodiment of the disclosure. Referring to FIG. 1 and FIG. 3, the method of FIG. 3 may be implemented by the information display system 100 of FIG. 1A.

In step S310, the processing apparatus 130 may obtain a capture angle of each of the image sensors 120_1˜120_N. In some embodiments, the processing apparatus 130 may obtain sensing specification information of each image sensor 120_1 to 120_N, such as image frame width, image frame height, or image frame frequency, etc. Then, the processing apparatus 130 may set the image correction parameters of each image sensor 120_1 to 120_N according to the capture angle of each image sensor 120_1 to 120_N. The above image correction parameters may include image scaling parameters or image geometric correction parameters. The image geometric correction parameters are, for example, image offset parameters or image rotation parameters, etc.

In some embodiments, the capture angle of each image sensor 120_1 to 120_N may include a roll angle, a pitch angle, a yaw angle), etc. In some embodiments, the capture angle of each image sensor 120_1 to 120_N may be detected and obtained by a gravity sensor or an inertial sensor installed on each image sensor 120_1 to 120_N.

In step S320, the processing apparatus 130 may perform an image stitching processing according to the capture angle of each image sensor 120_1 to 120_N to generate a stitching image. In this embodiment, step S320 may be implemented as step S321 to step S322.

In step S321, the processing apparatus 130 may perform image geometric correction processing on the first image and/or the second image according to the capture angle of the first image sensor 120_1 and the capture angle of the second image sensor 120_2 to generate at least one corrected image. According to the image correction parameters determined based on the capture angle, the processing apparatus 130 may perform image geometric correction processing on part or all of the images configured to generate the stitching image. The image geometry correction processing may include image offset processing, image rotation processing, or other image geometry correction processing. That is, the processing apparatus 130 may perform image geometric correction processing on the first image and the second image respectively to generate two corrected images. Alternatively, the processing apparatus 130 may perform image geometric correction processing on one of the first image and the second image to generate a corrected image.

In step S322, the processing apparatus 130 may perform the image stitching processing based on at least one correction image to generate a stitching image. The processing apparatus 130 may crop the image overlapping area from the correction image, and then stitch the cropped correction image with another image or another correction image to generate a stitching image. Alternatively, the processing apparatus 130 may crop the image overlapping area from the first image, and then stitch the cropped first image and the corrected image of the second image to generate a stitching image.

In some embodiments, the processing apparatus 130 may further standardize the stitching image according to the stitching specification settings to output a stitching image that conforms to the stitching specification settings. Standardization processing includes adjusting the stitching image to fit the preset size, or cropping the stitching image according to the preset cropping range, etc.

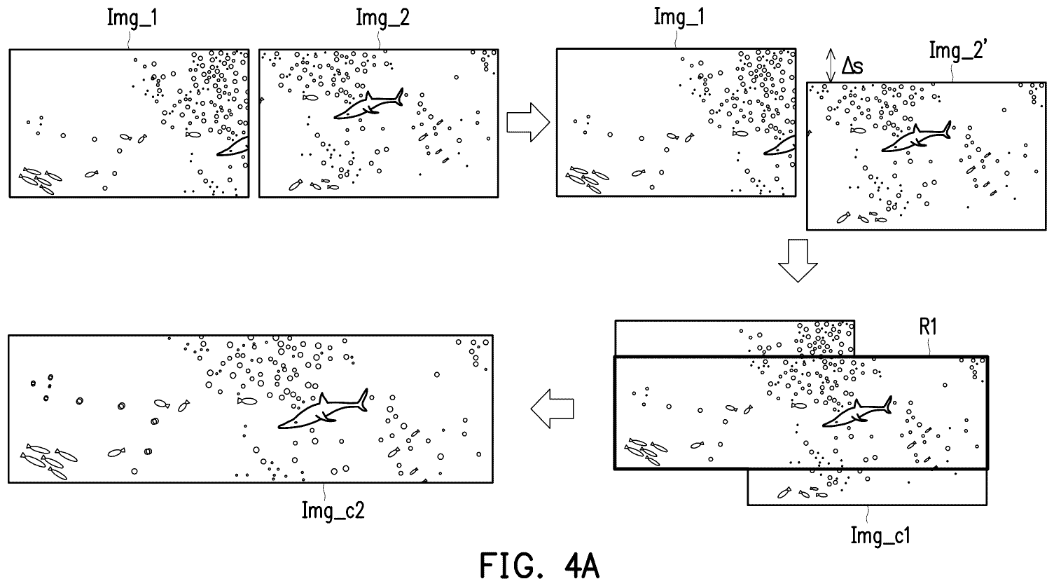

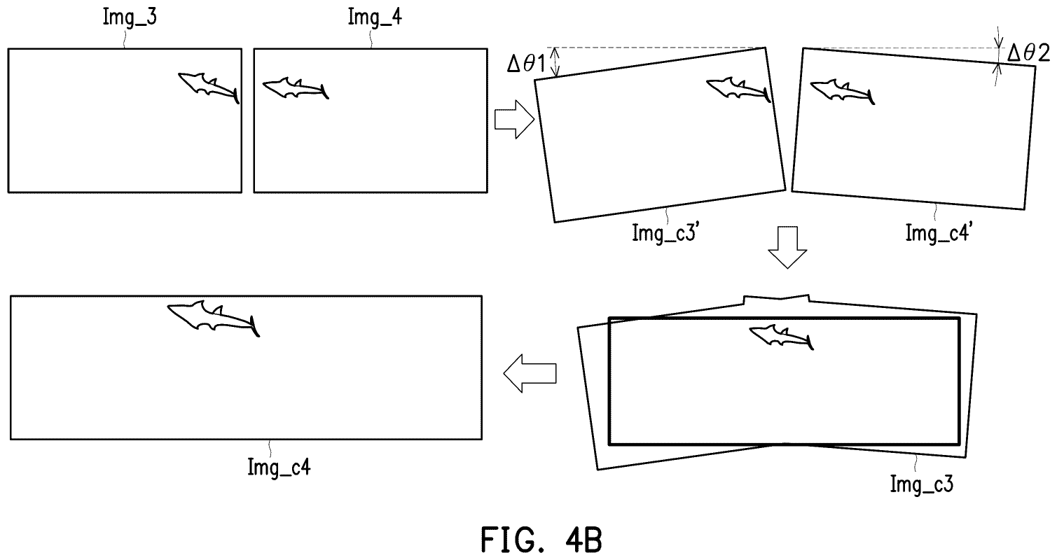

For example, FIG. 4A and FIG. 4B are schematic diagrams of generating a stitching image according to an exemplary embodiment of the disclosure. Referring to FIG. 4A, the first image sensor 120_1 may generate the first image Img_1, and the second image sensor 120_2 may generate the second image Img_2. The processing apparatus 130 may determine the image offset parameter Δs according to the angle difference between the shooting pitch angle of the first image sensor 120_1 and the shooting pitch angle of the second image sensor 120_2. Then, the processing apparatus 130 may perform image geometric correction processing (i.e., image offset processing) on the second image Img_2 according to the image offset parameter Δs, and obtain the corrected image Img_2′. After cutting the image overlapping area of the first image Img_1, the processing apparatus 130 may stitch the first image Img_1 and the corrected image Img_2′ to generate the stitching image Img_c1. In this example, since the outer edge of the image of the stitching image Img_c1 is not rectangular, the processing apparatus 130 may crop the stitching image Img_c1 according to the preset cropping range R1 to obtain a stitching image Img_c2 that conforms to the preset size and is rectangular. Afterwards, the processing apparatus 130 may perform image object recognition processing on the stitching image Img_c2.

Referring to FIG. 4B, the first image sensor 120_1 may generate the first image Img_3, and the second image sensor 120_2 may generate the second image Img_4. The processing apparatus 130 may determine the image rotation parameters 401 and 402 based on the shooting roll angle of the first image sensor 120_1 and the shooting roll angle of the second image sensor 120_2. Then, the processing apparatus 130 may perform image geometric correction processing (i.e., image rotation processing) on the first image Img_3 according to the image rotation parameter 401, and obtain the corrected image Img_3′. The processing apparatus 130 may perform image geometric correction processing (i.e., image rotation processing) on the second image Img_4 according to the image rotation parameter 402 to obtain the corrected image Img_4′. After cropping the image overlapping area of the corrected image Img_3′ or the corrected image Img_4′, the processing apparatus 130 may stitch the corrected image Img_3′ and the corrected image Img_4′ to generate a stitching image Img_c3. In this example, the processing apparatus 130 may crop the stitching image Img_c3 according to the preset cropping range R2 to obtain the stitching image Img_c4 that conforms to the preset size and predetermined shape. Afterwards, the processing apparatus 130 may perform image object recognition processing on the stitching image Img_c4.

Various implementations of generating object fusion information may be described in more detail below. For convenience and clear explanation, subsequent embodiments may take the example of information fusion of the object information of the first image sensor 120_1 and the object information of the second image sensor 120_2 as an example. From another view, the first image sensor 120_1 and the second image sensor 120_2 may be the first image sensor 120a_1 and the second image sensor 120a_2 or the first image sensor 120b_1 and the second image sensor 120b_2 of FIG. 1B.

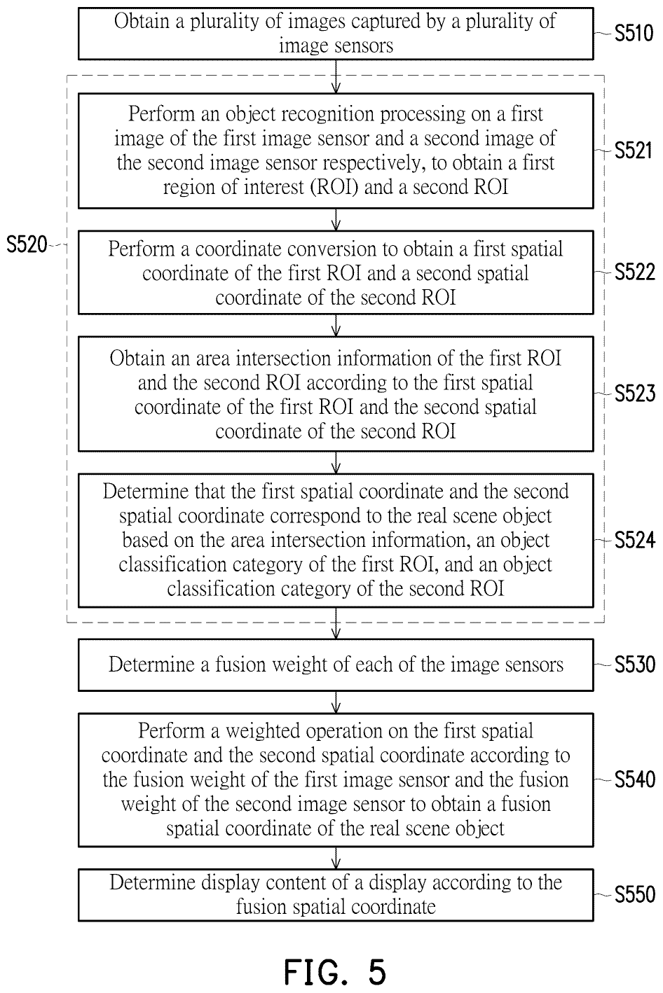

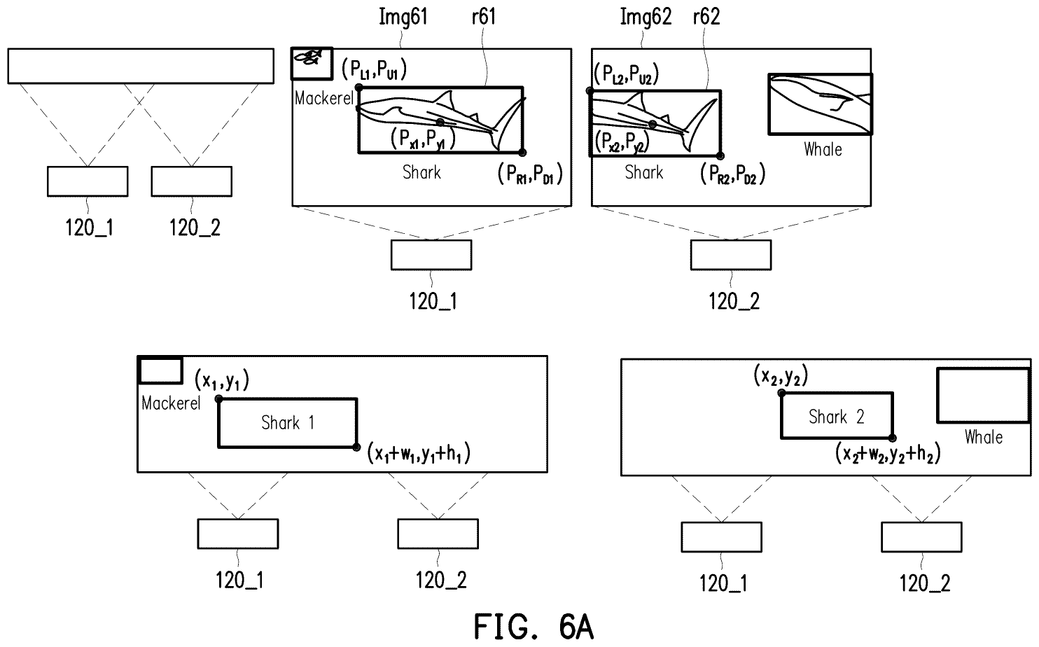

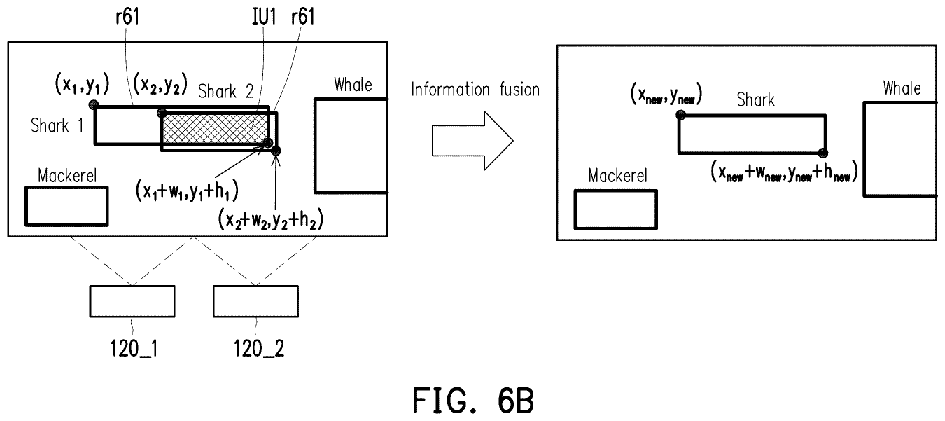

FIG. 5 is a flowchart of a multi-sensor coordination method according to an exemplary embodiment of the disclosure. The method of FIG. 5 may be implemented by the information display system 100 of FIG. 1A. In addition, for clearer explanation, this embodiment may be explained together with FIG. 6A and FIG. 6B. FIG. 6A is a schematic diagram of generating spatial coordinates associated with an image according to an exemplary embodiment of the disclosure. FIG. 6B is a schematic diagram illustrating calculation of area intersection information and generation of fusion spatial coordinates according to an exemplary embodiment of the disclosure. Referring to FIG. 5, FIG. 6A and FIG. 6B together.

In this embodiment, the plurality of object information of the real scene object include the first spatial coordinate associated with the first image sensor 120_1 and the second spatial coordinate associated with the second image sensor 120_2.

In step S510, the processing apparatus 130 may obtain images captured by the image sensors 120_1 and 120_2. The first image sensor 120_1 generates the first image Img_61, and the second image sensor 120_2 generates the first image Img_62. In this example, the first image sensor 120_1 and the second image sensor 120_2 may be arranged horizontally adjacent to the left and right. Due to the overlapping of the sensing fields of view, the first image sensor 120_1 and the second image sensor 120_2 may capture images of the same real scene object.

In step S520, the processing apparatus 130 may perform object recognition processing on the image or the stitching image of the images to obtain multiple the plurality of object information of the real scene object. In this embodiment, step S520 may be implemented as step S521 to step S524.

In step S521, the processing apparatus 130 may perform the object recognition processing on the first image Img_61 of the first image sensor 120_1 and the second image Img_62 of the second image sensor 120_2 respectively, and may obtain the first region of interest (ROI) r61 and the second ROI r62. In some embodiments, the above-mentioned ROIs may be an object bounding box (Bounding BOX) output by the CNN model.

In step S522, the processing apparatus 130 may perform coordinate conversion on the first ROI r61 of the first image Img_61 and the second ROI r62 of the second image Img_62, respectively, to obtain the first spatial coordinate of the first ROI r61 and the second spatial coordinate of the second ROI r62. The processing apparatus 130 may convert pixel coordinates into spatial coordinates under a reference spatial coordinate system (e.g., world coordinate system).

As shown in FIG. 6A, the pixel coordinates of the upper left corner and the lower right corner of the first ROI r61 in the first image Img_61 are (P_{L1}, P_{U1}) and (P_{R1}, P_{D1}) respectively, and the pixel position of the center point of the first ROI r61 Labeled (Pₓ₁, P_{y1}). In addition, the pixel coordinates of the upper left corner and the lower right corner of the second ROI r62 in the second image Img_62 are (P_{L2}, P_{U2}) and (P_{R2}, P_{D2}) respectively, and the pixel coordinates of the center point of the second ROI r62 are (Pₓ₂, P_{y2}).

In some embodiments, according to the camera parameters and sensing position information of the first image sensor 120_1, the processing apparatus 130 may convert the pixel coordinates of the first ROI r61 into the spatial coordinates under the reference space coordinate system (such as the world coordinate system). As shown in FIG. 6A, the pixel coordinate (P_{L1}, P_{U1}) of the upper left corner of the first ROI r61 may be converted into spatial coordinates (x₁, y₁). First, the pixel coordinates (P_{R1}, P_{D1}) of the lower right corner of the ROI r61 may be converted into spatial coordinates (x₁+w₁,y₁+h₁). On the other hand, according to the camera parameters and sensing position information of the second image sensor 120_2, the processing apparatus 130 may convert the pixel coordinates of the second ROI r62 into spatial coordinates under the reference space coordinate system (such as the world coordinate system). As shown in FIG. 6A, the pixel coordinates (P_{L2}, P_{U2}) of the upper left corner of the second focus area r62 may be converted into spatial coordinates (x₂,y₂). The pixel coordinates (P_{R2}, P_{D2}) of the lower right corner of the ROI r62 may be converted into spatial coordinates (x₂+w₂, y₂+h₂).

Next, in step S523, the processing apparatus 130 may obtain the area intersection information of the first ROI and the second ROI according to the first spatial coordinate of the first ROI r61 and the second spatial coordinate of the second ROI r62. In step S524, the processing apparatus 130 may determine that the first spatial coordinate and the second spatial coordinate correspond to the real scene object based on the area intersection information, an object classification category of the first ROI, and an object classification category of the second ROI.

Before performing information fusion on the object information, the processing apparatus 130 may first confirm whether different object information corresponds to the same real scene object. In some embodiments, when the area intersection information of the first ROI r61 and the second ROI r62 is greater than the preset threshold, and the first ROI r61 and the second ROI r62 correspond to the same object classification category, the processing apparatus 130 may determine the first spatial coordinate and the second spatial coordinate correspond to the same real scene object.

In some embodiments, the area intersection information between the first ROI r61 and the second ROI r62 may be an intersection over union between the two areas. The intersection over union may be configured to evaluate the degree of overlap between the first ROI r61 and the second ROI r62, and the intersection over union may be the ratio between the intersection area of the first ROI r61 and the second ROI r62 and the union area of the first ROI r61 and the second ROI r62.

As shown in FIG. 6B, according to the spatial coordinates of the first ROI r61 and the spatial coordinates of the second ROI r62, the processing apparatus 130 may obtain the intersection area IU1 between the first ROI r61 and the second ROI r62. The processing apparatus 130 may determine the spatial coordinates (x₁, y₁), (x₁+w₁,y₁+h₁) and spatial coordinates (x₂,y₂), (x₂+w₂, y₂+h₂) all correspond to the same real scene object (i.e., shark) according to the intersection over union of the intersection area IU1, the object classification category of the first ROI r61, and the object classification category of the second ROI r62.

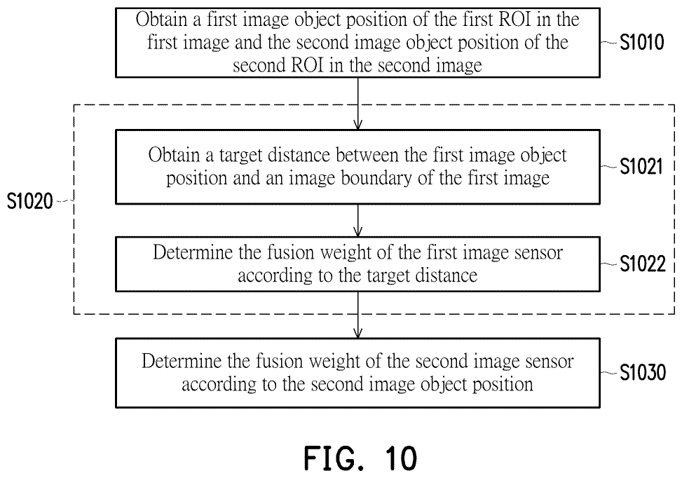

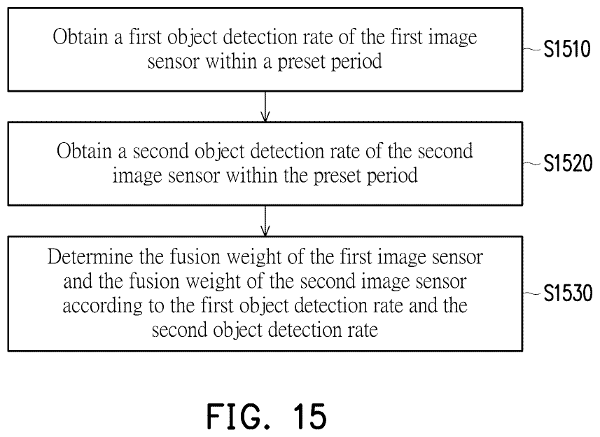

In step S530, the processing apparatus 130 may determine the fusion weight of each image sensor 120_1 and 120_2. For example, the method of determining the fusion weight of the image sensor may refer to the embodiment shown in FIG. 10 or the embodiment shown in FIG. 15. In step S540, the processing apparatus 130 may perform a weighted operation on the first spatial coordinate and the second spatial coordinate according to the fusion weight of the first image sensor 120_1 and the fusion weight of the second image sensor 120_2 to obtain the fusion spatial coordinates of the real scene object.

As shown in FIG. 6B, the processing apparatus 130 may obtain the fusion space coordinates of real scene object including (x_{new}, y_{new}), (x_{new}+w_{new}, y_{new}+h_{new}). Assuming that the fusion weight of first image sensor 120_1 is Wₚ and the fusion weight of second image sensor 120_2 is Wₛ, then the fusion spatial coordinate (x_{new}>y_{new}) may be obtained based on the following weighting formula (1) and weighting formula (2).

$${x}_{n e w} = \frac{{W}_{p} \times {x}_{1} + {W}_{s} \times {x}_{2}}{{W}_{p} + {W}_{s}} \qquad Formula ( 1 )$$

$${y}_{n e w} = \frac{{W}_{p} \times {y}_{1} + {W}_{s} \times {y}_{2}}{{W}_{p} + {W}_{s}} \qquad Formula ( 2 )$$

Based on the same calculation principle, the processing apparatus 130 may calculate the fusion space coordinate (x_{new}+w_{new}, y_{new}+h_{new}) according to the fusion weight Wₚ and the fusion weight Wₛ.

In step S550, the processing apparatus 130 may determine the display content of the display 110 based on the fusion space coordinate. For example, taking FIG. 1B as an example, after obtaining the fusion space coordinates of the target Obj1 according to the process shown in FIG. 5, the fusion space coordinates of the target Obj1 may be configured to determine the display position of the display information vf1.

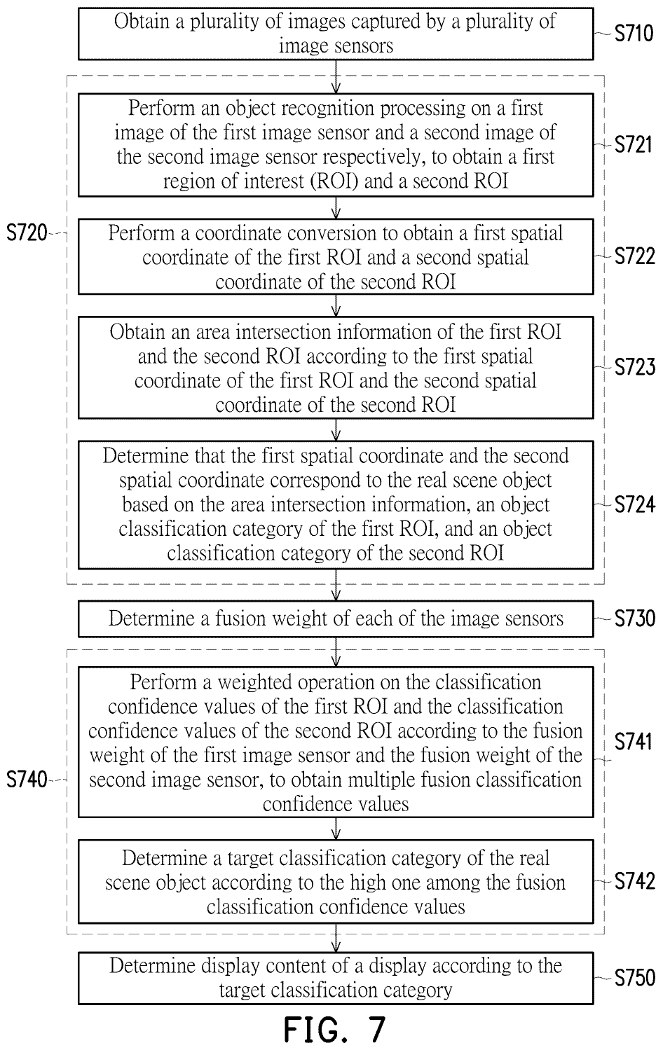

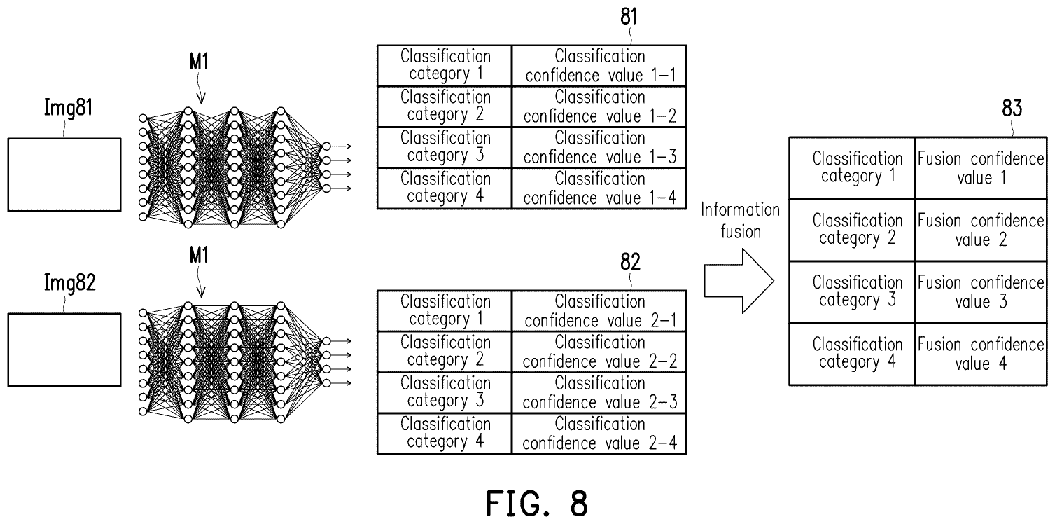

FIG. 7 is a flowchart of a multi-sensor coordination method according to an exemplary embodiment of the disclosure. The method of FIG. 7 may be implemented by the information display system 100 of FIG. 1A. In addition, for clearer explanation, this embodiment may be explained together with FIG. 8. FIG. 8 is a schematic diagram of obtaining multiple fusion classification confidence values according to an exemplary embodiment of the disclosure. Referring to FIG. 7 and FIG. 8 together.

In this embodiment, a convolutional neural network model M1 may be used for object recognition processing. The above-mentioned convolutional neural network model M1 may include a yolo model, a Faster R-CNN model, an SSD model or other object detection models, and this disclosure is not limited thereto.

In step S710, the processing apparatus 130 may obtain images captured by the image sensors 120_1 and 120_2. The first image sensor 120_1 generates the first image Img_81, and the second image sensor 120_2 generates the first image Img_82. Due to the overlapping of the sensing fields of view, the first image sensor 120_1 and the second image sensor 120_2 may capture images of the same real scene object.

In step S720, the processing apparatus 130 may perform an object recognition processing on the image or the stitching image of the images, and may obtain a plurality of object information of the real scene object. In this embodiment, step S720 may be implemented as step S721 to step S724.

In step S721, the processing apparatus 130 may perform the object recognition processing on the first image Img_81 of the first image sensor 120_1 and the second image Img_82 of the second image sensor 120_2 respectively, to obtain the first ROI and the second ROI. In step S722, the processing apparatus 130 may perform coordinate conversion on the first ROI of the first image Img_81 and the second ROI of the second image Img_82 respectively to obtain the first spatial coordinate of the first ROI and the second spatial coordinate of the second ROI.

In step S723, the processing apparatus 130 may obtain the area intersection information of the first ROI and the second ROI based on the first spatial coordinate of the first ROI and the second spatial coordinate of the second ROI. In step S724, the processing apparatus 130 may determine that the first spatial coordinate and the second spatial coordinate correspond to the real scene object based on the area intersection information, an object classification category of the first ROI, and an object classification category of the second ROI. For implementation details of steps S721 to step S724, please refer to the description of the embodiment in FIG. 5 and may not be described again here.

It should be noted that, in this embodiment, the first image Img_81 and the second image Img_82 may be input to the convolutional neural network model M1 respectively for object recognition processing. The convolutional neural network model M1 may output the object recognition result of the first image Img_81 and the object recognition result of the second image Img_82. The object recognition results include an object bounding box (i.e., a first ROI and a second ROI) and a plurality of classification confidence values 81 and 82 for the object bounding box being classified into multiple classification categories. These classification confidence values may be, for example, probability values. That is to say, for each classification category, the convolutional neural network model M1 may generate a corresponding classification confidence value for the object bounding box.

In step S730, the processing apparatus 130 may determine the fusion weight of each image sensor 120_1 and 120_2. For example, the method of determining the fusion weight of the image sensor may refer to the embodiment shown in FIG. 10 or the embodiment shown in FIG. 15. In step S740, the processing apparatus 130 may perform the information fusion processing on a plurality of object information according to the fusion weights of the image sensor 120_1 and 120_2, and may obtain object fusion information of real scene object. In this embodiment, the plurality of object information of real scene object include multiple classification confidence values 81 and 82 output by the convolutional neural network model M1 based on the first image Img_81 and the second image Img_82. Step S740 may be implemented as step S741 to step S742.

In step S741, the processing apparatus 130 may perform a weighted operation on the classification confidence values 81 of the first ROI and the classification confidence values 82 of the second ROI based on the fusion weight of the first image sensor 120_1 and the fusion weight of the second image sensor 120_2, to obtain multiple fusion classification confidence values 83.

Furthermore, after the processing apparatus 130 inputs the first image Img_81 to the convolutional neural network model M1, the processing apparatus 130 may obtain multiple classification confidence values 81 of the first ROI in the first image Img_81. After the processing apparatus 130 inputs the second image Img_82 to the convolutional neural network model M1, the processing apparatus 130 may obtain multiple classification confidence values 82 of the first ROI in the second image Img_82. Afterwards, the processing apparatus 130 may perform a weighted sum operation on the classification confidence value 81 and the classification confidence value 82 associated with the same classification category to obtain the fusion classification confidence value of each classification category. For example, as shown in FIG. 8, the processing apparatus 130 may perform a weighted operation on the “classification confidence value 1-1” and the “classification confidence value 2-1” to generate a “fusion classification confidence value 1” of “classification category 1”. In the example of FIG. 8, the processing apparatus 130 may generate, for example, four fusion classification confidence values 83.

In step S742, the processing apparatus 130 may determine the target classification category of the real scene object based on the highest one among the fusion classification confidence values 83. For example, as shown in FIG. 8, when the processing apparatus 130 may determine that the highest one among the fusion classification confidence values 83 is “fusion classification confidence value 3”, the processing apparatus 130 may decide to recognize the real scene object as the target classification category (i.e. “Classification Category 3”).

In step S750, the processing apparatus 130 may determine the display content of the display 110 according to the target classification category. For example, taking FIG. 1B as an example, after obtaining the target classification category of the target object Obj1 according to the process shown in FIG. 7, the target classification category of the target object Obj1 may be used to determine the information content of the display information vf1.

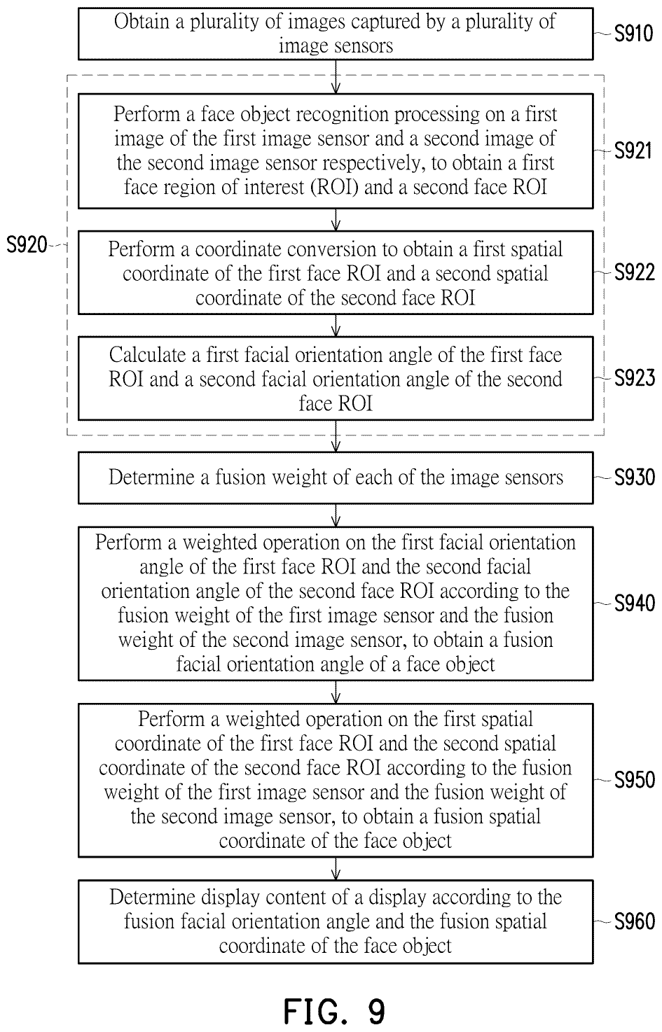

FIG. 9 is a flowchart of a multi-sensor coordination method according to an exemplary embodiment of the disclosure. The method flow of FIG. 9 may be implemented by the information display system 100 of FIG. 1A.

In step S910, the processing apparatus 130 may obtain images captured by the image sensors 120_1 and 120_2. The first image sensor 120_1 may generate a first image, and the second image sensor 120_2 may generate a second image.

In step S920, the processing apparatus 130 may perform an object recognition processing on the image or the stitching image of the images, to obtain a plurality of object information of the real scene object. In this embodiment, the plurality of object information include the first facial orientation angle sensed by the first image sensor 120_1 and the second facial orientation angle sensed by the second image sensor 120_2. Correspondingly, step S920 may be implemented as step S921 to step S923.

In step S921, the processing apparatus 130 may perform a face object recognition processing on the first image of the first image sensor 120_1 and the second image of the second image sensor 120_2 respectively, to obtain a first face ROI and the second face ROI. In step S922, the processing apparatus 130 may perform coordinate conversion on the first face ROI of the first image and the second face ROI of the second image respectively, to obtain the first spatial coordinate of the first face ROI and the second space coordinate of the second face ROI. In step S923, the processing apparatus 130 may calculate the first facial orientation angle of the first face ROI and the second facial orientation angle of the second face ROI. Here, the facial orientation angle represents the orientation angle of the face, which may be represented by the Euler angle. That is, the facial orientation angle may be the face pitch angle, the face yaw angle, or the face roll angle.

In some embodiments, the processing apparatus 130 may perform facial key point detection on the facial ROI to obtain multiple facial feature points. These facial feature points may include eye feature points, mouth feature points, nose feature points, eyebrow feature points, facial contour feature points, etc. Afterwards, the processing apparatus 130 may use mathematical methods (such as trigonometric functions or vector calculations) to infer the orientation angle of the human face based on the key point positions of the human facial key points. For example, the processing apparatus 130 may use the positions of the eye feature points to calculate the facial orientation angle.

In step S930, the processing apparatus 130 may determine the fusion weight of each image sensor 120_1˜120_N. For example, the method of determining the fusion weight of the image sensor may refer to the embodiment shown in FIG. 10 or the embodiment shown in FIG. 15.

In step S940, the processing apparatus 130 may perform a weighted operation on the first facial orientation angle and the second facial orientation angle according to the fusion weight of the first image sensor 120_1 and the fusion weight of the second image sensor 120_2 to obtain the fusion facial orientation angle of the face object. For example, the fusion pitch angle pitch_{new} of a human face object may be obtained according to the following weighted formula (3).

$${pitch}_{n e w} = \frac{{W}_{p} \times {pitch}_{1} + {W}_{s} \times {pitch}_{2}}{{W}_{p} + {W}_{s}} \qquad Formula ( 3 )$$

Among them, pitch1 is the first pitch angle sensed by the first image sensor 120_1; pitch2 is the second pitch angle sensed by second image sensor 120_2; W_{P} is the fusion weight of first image sensor 120_1; W_{S} is the fusion weight of second image sensor 120_2.

In step S950, the processing apparatus 130 may perform a weighted operation on the first spatial coordinate and the second spatial coordinate according to the fusion weight of the first image sensor and the fusion weight of the second image sensor to obtain a fusion spatial coordinate of the face object. The implementation details and principles of obtaining the fusion spatial coordinates in step S950 may be similar to the embodiment of FIG. 5 and may not be described again here.

In step S960, the processing apparatus 130 may determine the display content of the display 110 based on the fusion facial orientation angle and the fusion spatial coordinates. For example, taking FIG. 1B as an example, after obtaining the fusion space coordinates and fusion facial orientation angle of user U1 according to the process shown in FIG. 9, the fusion space coordinates and fusion facial orientation angle of user U1 may be configured to determine the display position of the display information vf1 (may be used as part of the display content).

FIG. 10 is a flowchart of determining fusion weights according to an exemplary embodiment of the disclosure. In this embodiment, the processing apparatus 130 may determine the fusion weight of the first image sensor 120_1 according to the first image object position of the recognized image object in the first image of the first image sensor 120_1. Similarly, the processing apparatus 130 may determine the fusion weight of the second image sensor 120_2 based on the second image object position of the recognized image object in the second image of the second image sensor 120_2. Referring to FIG. 10.

In step S1010, after performing the image object recognition processing on the first image and the second image respectively, the processing apparatus 130 may obtain the first image object position of the first ROI in the first image and the second image object position of the second ROI in the second image. The first image object position and the second image object position are, for example, the center point position of the object bounding box (i.e., the ROI), the corner point position, or other reference point positions within the object bounding box.

In step S1020, the processing apparatus 130 may determine the fusion weight of the first image sensor 120_1 based on the first image object position. In this embodiment, step S1020 may be implemented as step S1021 and step S1022.

In step S1021, the processing apparatus 130 may obtain a target distance between the first image object position and an image boundary of the first image. In step S1022, the processing apparatus 130 may determine the fusion weight of the first image sensor 120_1 according to the target distance. In some embodiments, the target distance is positively correlated with the fusion weight of the first image sensor 120_1. As the first image object position in the first image is closer to the center of the image, the fusion weight of the first image sensor 120_1 may be larger. The magnitude of target distance may indicate whether the first image object is located close to the center of the image. In some embodiments, the fusion weight of the first image sensor 120_1 is the N^{th} power of the target distance, and N is greater than 0.

In some embodiments, the processing apparatus 130 may calculate a first reference distance between the first image object position and the first reference image boundary of the first image. The processing apparatus 130 may calculates a second reference distance between the first image object position and the second reference image boundary of the first image. The first reference image boundary is parallel to the second reference image boundary. The processing apparatus 130 uses the smaller one among the first reference distance and the second reference distance as the target distance. The first reference image boundary and the second reference image boundary may be two vertical image boundaries. Alternatively, the first reference image boundary and the second reference image boundary may be two horizontal image boundaries.

In some embodiments, the processing apparatus 130 may determine whether the first reference image boundary and the second reference image boundary are the vertical image boundary or the horizontal image boundary according to the arrangement of the first image sensor 120_1 and the second image sensor 120_2. Furthermore, when the first image sensor 120_1 and the second image sensor 120_2 are arranged left and right along the horizon direction, the first reference image boundary and the second reference image boundary may be vertical image boundaries. When the first image sensor 120_1 and the second image sensor 120_2 are arranged up and down along the vertical direction, the first reference image boundary and the second reference image boundary may be horizontal image boundaries.

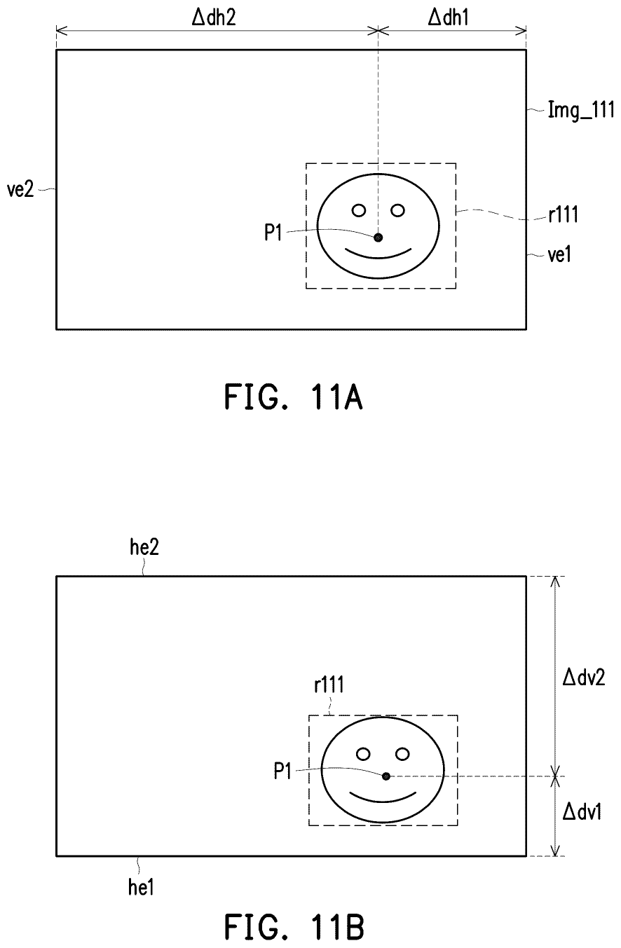

FIG. 11A and FIG. 11B are schematic diagrams of determining fusion weights according to an exemplary embodiment of the disclosure. Referring to FIG. 11A, the first image sensor 120_1 may generate the first image Img111, and the processing apparatus 130 may recognize the face object from the first image Img111 and obtain the face ROI r111. In the example of FIG. 11A, the first image sensor 120_1 and the second image sensor 120_2 are installed horizontally. The processing apparatus 130 may calculate the first reference distance Adh1 between the first image object position P1 of the face ROI r111 and the first reference image boundary ve1 of the first image Img111. The processing apparatus 130 may calculate the second reference distance Adh2 between the first image object position P1 of the face ROI r111 and the second reference image boundary ve2 of the first image Img111. The first reference image boundary ve1 and the second reference image boundary ve2 are vertical image boundaries. Since the first reference distance Adh1 is smaller than the second reference distance Adh2, the processing apparatus 130 may determine the first reference distance Adh1 as the target distance to obtain the fusion weight of the first image sensor 120_1 based on the first reference distance Adh1.

For example, the processing apparatus 120 may obtain the fusion weight W_{P} of the first image sensor 120_1 according to the following formula (4) and formula (5).

$$MinimumPixel = minimum ( {P}_{x} , Width - {P}_{x} ) \qquad Formula ( 4 )$$

$${W}_{P} = {MinimumPixel}^{N} \qquad Formula ( 5 )$$

Among them, Pₓ represents the first reference distance; Width-Pₓ represents second reference distance; Width represents image width; minimum(·) represents taking the minimum value; MinimumPixel responsible for the target distance.

Referring to FIG. 11B, the first image sensor 120_1 may generate the first image Img111, and the processing apparatus 130 may recognize the face object from the first image Img111 and obtain the face ROIr111. In the example of FIG. 11B, the first image sensor 120_1 and the second image sensor 120_2 are installed vertically. The processing apparatus 130 may calculate the first reference distance Adv1 between the first image object position P1 of the face ROI r111 and the first reference image boundary he1 of the first image Img111. The processing apparatus 130 may calculate the second reference distance Adv2 between the first image object position P1 of the face ROI r111 and the second reference image boundary he2 of the first image Img111. The first reference image boundary he1 and the second reference image boundary he2 are horizontal image boundaries. Since the first reference distance Adv1 is smaller than the second reference distance Adv2, the processing apparatus 130 may use the first reference distance Adv1 as the target distance to obtain the fusion weight of the first image sensor 120_1 based on the first reference distance Adv1.

For example, the processing apparatus 120 may obtain the fusion weight W_{P} of the first image sensor 120_1 according to the following formula (6) and formula (7).

$$MinimumPixel = minimum ( {P}_{y} , Height - {P}_{y} ) \qquad Formula ( 6 )$$

$${W}_{P} = {MinimumPixel}^{N} \qquad Formula ( 7 )$$

Among them, P_{y} represents the first reference distance; Height-P_{y} represents second reference distance; Height represents image height; minimum(·) represents taking the minimum value; Minimum Pixel responsible for the target distance.

In step S1030, the processing apparatus 130 may determine the fusion weight of the second image sensor 120_2 based on the second image object position. The principle and method of determining the fusion weight of the second image sensor 120_2 by the processing apparatus 130 may be similar to the principle and method of determining the fusion weight of the first image sensor 120_1, which may not be described again here.

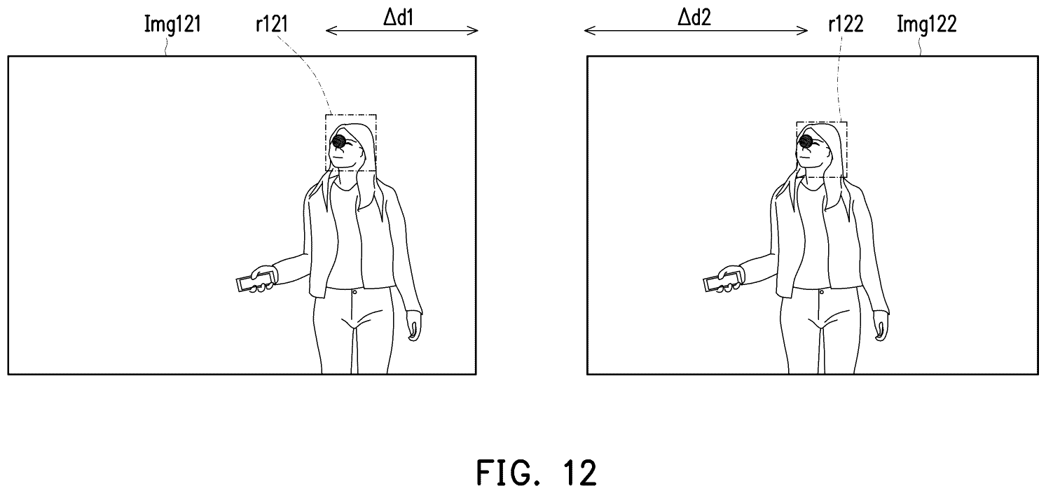

FIG. 12 is a schematic diagram of obtaining the fusion facial orientation angle and fusion spatial coordinates according to an exemplary embodiment of the disclosure. Referring to FIG. 12, the first image sensor 120_1 and the second image sensor 120_2 are installed horizontally. It is assumed that the resolutions of the first image sensor 120_1 and the second image sensor 120_2 are both 1280x800, and the sensing fields of the first image sensor 120_1 and the second image sensor 120_2 have overlapping areas.

The first image sensor 120_1 may generate the first image Img121, and the second image sensor 120_2 may generate the second image Img122. The processing apparatus 130 may recognize the face object from the first image Img121 and obtain the face ROI r121. The processing apparatus 130 may recognize the face object from the second image Img122 and obtain the face ROI r122. The image object position of the face ROI r121 (such as the position of glabella of the face) may be the pixel coordinate (912,221). The image object position of the face ROI r122 (such as the position of glabella of the face) may be the pixel coordinate (626,224). In addition, through the depth sensing technology, the processing apparatus 130 may obtain the depth value of the face ROI r121 as 1765 mm and the depth value of the face ROI r122 as 1763 mm. In addition, through the face angle recognition technology, the processing apparatus 130 may obtain the first face pitch angle of the face ROIr121 is 8.3 degrees and the second face pitch angle of the face ROI r122 is 11.3 degrees.

In the above condition, according to formula (4) and formula (5), the processing apparatus 130 may calculate the weight value Wₚ of the first image sensor 120_1 and the weight value W_{S} of the second image sensor 120_2. The target distance Δd1 of the face ROI r121 from the vertical image boundary is 368, and the weight value W_{P} of this first image sensor 120_1 is the N^{th} power of 368 (i.e. 1280-912). In addition, the target distance Ad2 of the face ROI r122 from the vertical image boundary is 626, and the weight value W_{S} of the second image sensor 120_2 is 626 to the N^{th} power. In this example, N may be equal to 1, then Wₚ-368 and Ws₌626.

Based on a calculation method similar to formula (3), the processing apparatus 130 may perform a weighted operation on the first face pitch angle of the first image Img121 and the second face pitch angle of the second image Img122 according to W_{P} and W_{S}, and the resulting fusion face pitch angle is 10.19 degrees.

In addition, through coordinate conversion, the processing apparatus 130 may convert the pixel coordinates (912, 221) and depth values of the face ROIr121 into first space coordinates (750, 503, 1747). Through coordinate conversion, the processing apparatus 130 may convert the pixel coordinates (626, 224) and depth values of the face ROI r122 into second space coordinates (762, 509, 1741).

Based on the calculation method similar to formula (1) and formula (2), the processing apparatus 130 may perform a weighted operation on the first spatial coordinate of the first image Img121 and the second spatial coordinate of the second image Img122 according to Wy and Ws. The resulting fusion space coordinates are (757.5, 506.5, 1743.2). For example, the processing apparatus 130 may perform a weighted operation on the X coordinate component of the first spatial coordinate and the X coordinate component of the second spatial coordinate according to W_{P} and W_{S} to generate an X coordinate component of the fusion spatial coordinate.

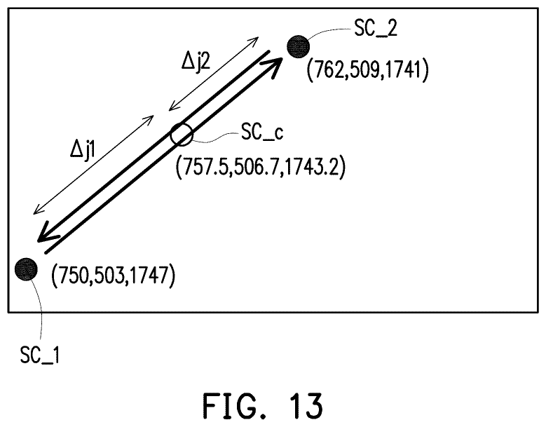

FIG. 13 is a schematic diagram of improving information jitter according to an exemplary embodiment of the disclosure. Referring to FIG. 13 and continue the description of the example of FIG. 12. In the traditional information filtering method, when both the first image sensor 120_1 and the second image sensor 120_2 detect the user, the second spatial coordinate SC_2 corresponding to the second image sensor 120_2 may be filtered out, and the processing apparatus 130 is only based on the first image. The first spatial coordinate SC_1 corresponding to the e first sensor 120_1 may used to determine the display content. Later, when the first image sensor 120_1 is not able to detect the user, the processing apparatus 130 may switch to using the second spatial coordinate SC_2 corresponding to the second image sensor 120_2 to determine the display content, causing the user's position information to directly change from the first spatial coordinate SC_1 to the second spatial coordinate SC_2. In other words, as shown in FIG. 13, in the traditional information filtering method, when the main image sensor is not able to detect the user, the jitter amount of the user's spatial coordinates is approximately Aj1+Aj2.

In contrast, in the method of the disclosure, when both the first image sensor 120_1 and the second image sensor 120_2 detect the user, the processing apparatus 130 may generate a fusion spatial coordinate SC_c based on the first spatial coordinate SC_1 and the second spatial coordinate SC_2. Later, when the first image sensor 120_1 or the second image sensor 120_2 is not able to detect the user, the processing apparatus 130 may switch to using the first spatial coordinate SC_1 corresponding to the first image sensor 120_1 or the second spatial coordinate SC_2 corresponding to the second image sensor 120_2 to decide what to display. In other words, as shown in FIG. 13, in the method of the disclosure, when an image sensor is not able to detect the user, the jitter amount of the user's spatial coordinates is approximately Aj1 or Aj2. It may be seen that, compared with the traditional information filtering method, the jitter amount of the user's spatial coordinate in the embodiment is smaller.

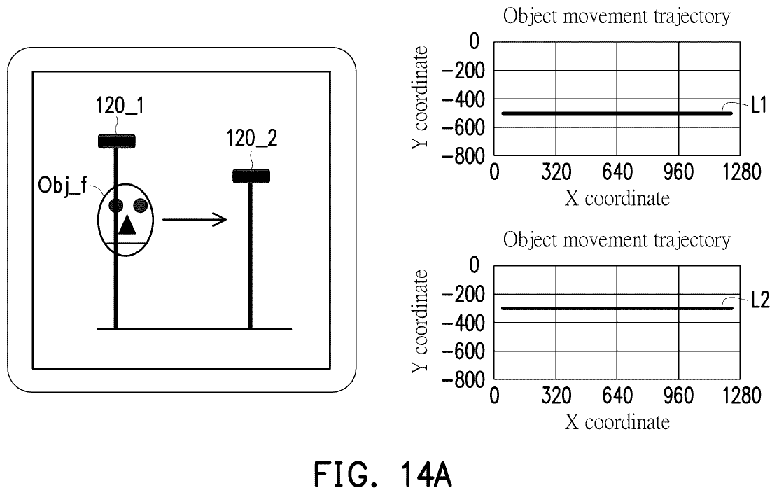

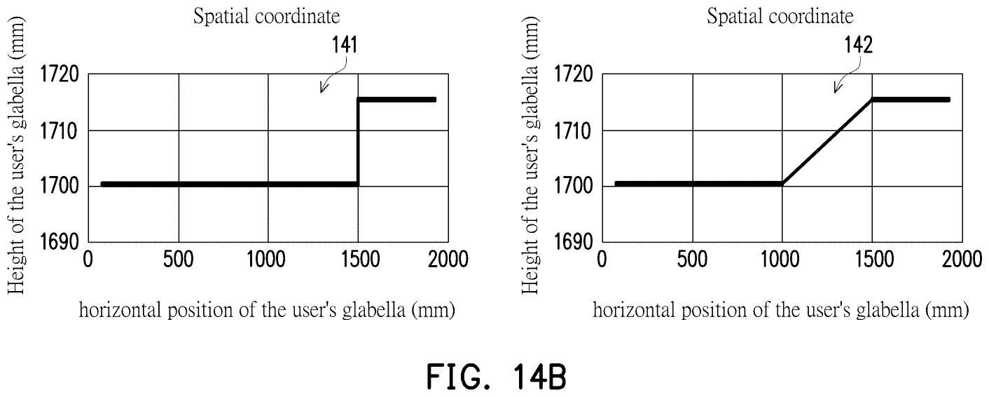

FIG. 14A and FIG. 14B are schematic diagrams of improving information jitter according to an exemplary embodiment of the disclosure. In scenarios where multiple image sensors are used, spatial coordinate conversion is required for filtering out duplicate image objects and information fusion. The accuracy of spatial coordinate conversion is related to the hardware setup parameters of these image sensors, and the above hardware setup parameters include the distance between image sensors, the acquisition direction and installation height of image sensing, etc.

Referring to FIG. 14A, the fixing mechanism of the second image sensor 120_2 may be loose or the second image sensor 120_2 may be moved by an external force, causing the installation height of the second image sensor 120_2 to decrease. In this case, when the user Obj_f moves from the first image sensor 120_1 to the second image sensor 120_2, the object movement trajectory of the face object sensed by the first image sensor 120_1 is, for example, the trajectory L1, and the object movement trajectory sensed by the second image sensor 120_2 is, for example, trajectory L2. Because the installation height of the second image sensor 120_2 decreases, the Y coordinate of the trajectory L2 is shifted upward compared to the Y coordinate of the trajectory L1.

Referring to FIG. 14B, the spatial coordinates 141 and 142 of the user Obj_f may be generated according to the trajectory L1 and the trajectory L2 of FIG. 14A. If the traditional information filtering method is configured to obtain the spatial coordinates 141 of the user Obj_f, the spatial coordinates 141 of the user Obj_f may cause information jitter at the intersection of the fields of view of the two image sensors. As shown in FIG. 14B, the Y component of the spatial coordinate of the user Obj_f may jump directly from 1700 to 1715 instantly, resulting in an obvious information jitter phenomenon. In contrast, if the information fusion method of the disclosure is configured to obtain the spatial coordinates 142 of the user Obj_f, the changes in the spatial coordinates 142 of the user Obj_f at the interface of the visual fields of the two image sensors are relatively smooth. As shown in FIG. 14B, the Y component of the spatial coordinate of user Obj_f may gradually change from 1700 to 1715 without obvious information jitter. In this case, the display content generated based on the disclosed method does not have obvious shaking or jittering.

FIG. 15 is a schematic diagram of determining fusion weights according to an exemplary embodiment of the disclosure. In this embodiment, the processing apparatus 130 may determine the fusion weight of each image sensor according to the object detection rate corresponding to each image sensor.

In step S1510, the processing apparatus 130 may obtain the first object detection rate of the first image sensor 120_1 within a preset period. In step S1520, the processing apparatus 130 may obtain the second object detection rate of the second image sensor 120_2 within the preset period. In step S1530, the processing apparatus 130 may determine the fusion weight of the first image sensor 120_1 and the fusion weight of the second image sensor 120_2 according to the first object detection rate and the second object detection rate.

For example, the first image sensor 120_1 may capture M first image frames in a preset period. The second image sensor 120_2 may capture M frames of second image in the same preset time period. The processing apparatus 130 may perform image object recognition processing on the M first image frames respectively, and respectively determine whether the correct object may be identified from the M first image frames. Based on the ratio of the number of first images that may identify correct objects to the total number of frames M, the processing apparatus 130 may obtain the first object detection rate of the first image sensor 120_1. In the same manner, the processing apparatus 130 may obtain the second object detection rate of the second image sensor 120_2.

In some embodiments, when the first object detection rate of the first image sensor 120_1 and the second object detection rate of the second image sensor 120_2 are greater than the preset threshold, the processing apparatus 130 may use the first object detection rate of the first image sensor 120_1 as the fusion weight of first image sensor 120_1 and use the second object detection rate of second image sensor 120_2 as the fusion weight of second image sensor 120_2.

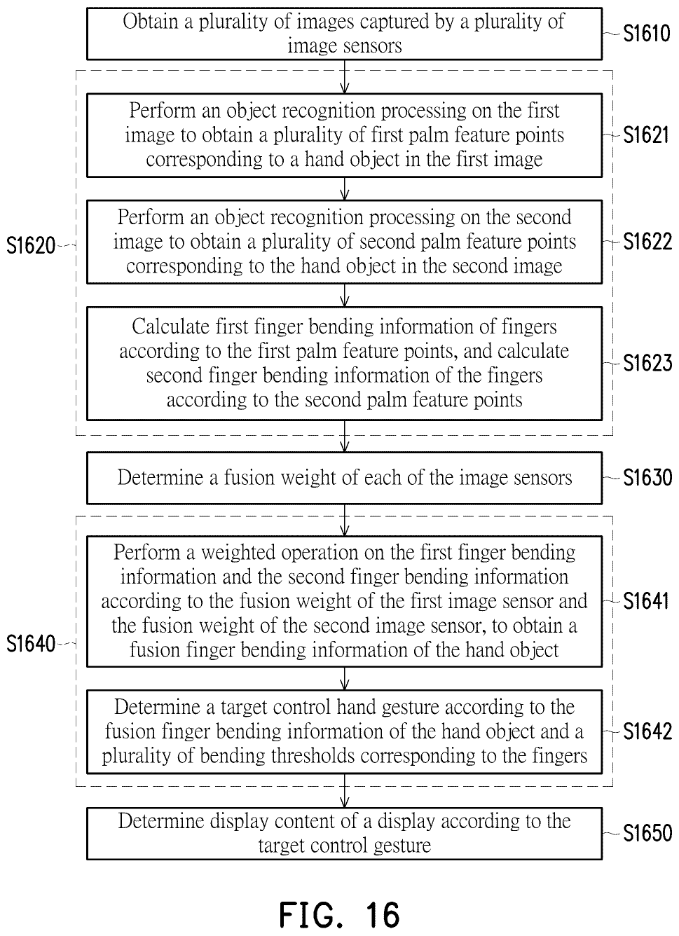

FIG. 16 is a flowchart of a multi-sensor coordination method according to an exemplary embodiment of the disclosure. The method flow of FIG. 16 may be implemented by the information display system 100 of FIG. 1A.

In step S1610, the processing apparatus 130 may obtain images captured by multiple image sensors 120_1 and 120_2. The first image sensor 120_1 produces the first image, and the second image sensor 120_2 produces the second image. Due to the overlapping of the sensing fields of view, the first image sensor 120_1 and the second image sensor 120_2 may capture images of the same real scene object.

In step S1620, the processing apparatus 130 may perform the object recognition processing on the image or the stitching image of the images, to obtain a plurality of object information of the real scene object. In this embodiment, the plurality of object information of the real scene object include first finger bending information sensed by the first image sensor 120_1 and second finger bending information sensed by the second image sensor 120_2. Step S1620 may be implemented as steps S1621 to step S1623.

In step S1621, the processing apparatus 130 may perform object recognition processing on the first image to obtain a plurality of first palm feature points corresponding to a hand object in the first image. In step S1622, the processing apparatus 130 may perform the object recognition processing on the second image to obtain a plurality of second palm feature points corresponding to the hand object in the second image.

In step S1623, the processing apparatus 130 may calculate the first finger bending information of each finger based on the first palm feature points, and may calculate the second finger bending information of each finger based on the second palm feature points. In the embodiment of the disclosure, first finger bending information and second finger bending information are numerical information that may indicate whether the finger is bent. In some embodiments, the processing apparatus 130 may determine the first finger bending information based on the distance between the first palm feature points, and determine the second finger bending information based on the distance between the second palm feature points.

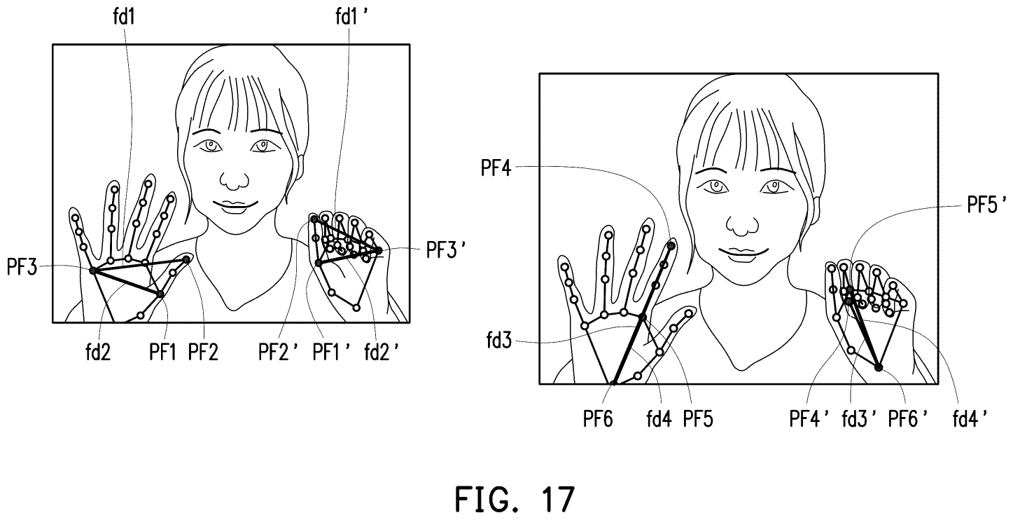

For example, FIG. 17 is a schematic diagram of obtaining finger bending information according to an exemplary embodiment of the disclosure. Referring to FIG. 17, the processing apparatus 130 may obtain multiple palm feature points (such as palm feature points PF1, PF2, PF3, PF1′, PF2′, PF3′, PF4, PF5, PF6, PF4′, PF5′ and PF6′).

When the finger bending information of the thumb is to be calculated, the processing apparatus 130 may calculate the distance fd2 between the palm feature points PF1 and PF3 and the distance fd1 between the palm feature points PF2 and PF3, and calculate the ratio between the distance fd1 and distance fd2 as the finger bending information of the thumb. Similarly, the processing apparatus 130 may calculate the distance fd2′ between the palm feature points PF1′ and PF3′ and the distance fd1′ between the palm feature points PF2′ and PF3′, and calculate the ration between the distance fd1′ and distance fd2′ as the finger bending information of a thumb.

In addition, when the finger bending information of the index finger is to be calculated, the processing apparatus 130 may calculate the distance fd3 between the palm feature points PF4 and PF6 and the distance fd4 between the palm feature points PF5 and PF6, and calculate the ratio between the distance fd3 and the distance fd4 as the finger bending information of the index finger. Similarly, the processing apparatus 130 may calculate the distance fd3′ between the palm feature points PF4′ and PF6′ and the distance fd4′ between the palm feature points PF5′ and PF6′, and calculate the ratio between the distance fd3′ and distance fd4′ as the finger bending information of an index finger.

It should be noted that, the finger bending information of other fingers may be generated based on similar principles and calculation methods. It may be seen that, the processing apparatus 130 may obtain the finger bending information of the five fingers in the images of different image sensors. It should be noted that in different embodiments, the coordinate positions of the palm feature points may be two-dimensional coordinates or three-dimensional coordinates, and may be implemented in different ways according to the feature point algorithm used in practice. In other words, the distance between palm feature points may be calculated based on two-dimensional coordinates or three-dimensional coordinates.

For example, assuming that the feature point coordinates of a certain palm feature point are (aₓ, a_{y}), and the feature point coordinates of another palm feature point are (bₓ, b_{y}), then the distance D(a, b) between the two palm feature points) may be characterized as the following formula (8).

$$D ( a , b ) = {[ {( {b}_{x} - {a}_{x} )}^{r} + {( {b}_{y} - {a}_{y} )}^{r} ]}^{\frac{1}{r}} \qquad Formula ( 8 )$$

Among them, r may be an even number greater than 0.

For example, assuming that the feature point coordinates of a certain palm feature point are (aₓ, a_{y}, a_{z}), and the feature point coordinates of another palm feature point are (bₓ, b_{y}, b_{z}), then the distance D(a, b) between the two palm feature points) may be characterized as the following formula (9).

$$D ( a , b ) = {[ {( {b}_{x} - {a}_{x} )}^{r} + {( {b}_{y} - {a}_{y} )}^{r} + {( {b}_{z} - {a}_{z} )}^{r} ]}^{\frac{1}{r}} \qquad Formula ( 9 )$$

Among them, r may be an even number greater than 0.

In step S1630, the processing apparatus 130 may determine the fusion weight of each image sensor 120_1˜120_N. The method of determining the fusion weight of the image sensor may refer to the embodiment of FIG. 10 or the embodiment of FIG. 15. For example, the processing apparatus 130 may determine the fusion weight of the first image sensor 120_1 based on the palm position of the first image of the first image sensor 120_1, and determine the fusion weight of the second image sensor 120_2 based on the palm position of the second image of the second image sensor 120_2.

In step S1640, the processing apparatus 130 may perform information fusion processing on a plurality of object information according to the fusion weights of each image sensor 120_1 to 120_N, and may obtain object fusion information of the real scene object. Step S1640 may be implemented as step S1641 to step S1642.

In step S1641, the processing apparatus 130 may perform a weighted operation on the first finger bending information and the second finger bending information according to the fusion weight of the first image sensor 120_1 and the fusion weight of the second image sensor 120_2 to obtain the fusion finger bending information of the hand object. In step S1642, the processing apparatus 130 may determine a target control gesture based on the fusion finger bending information of the hand object and a plurality of bending thresholds corresponding to the fingers. It should be noted that, in some embodiments, different fingers may correspond to different bending thresholds.

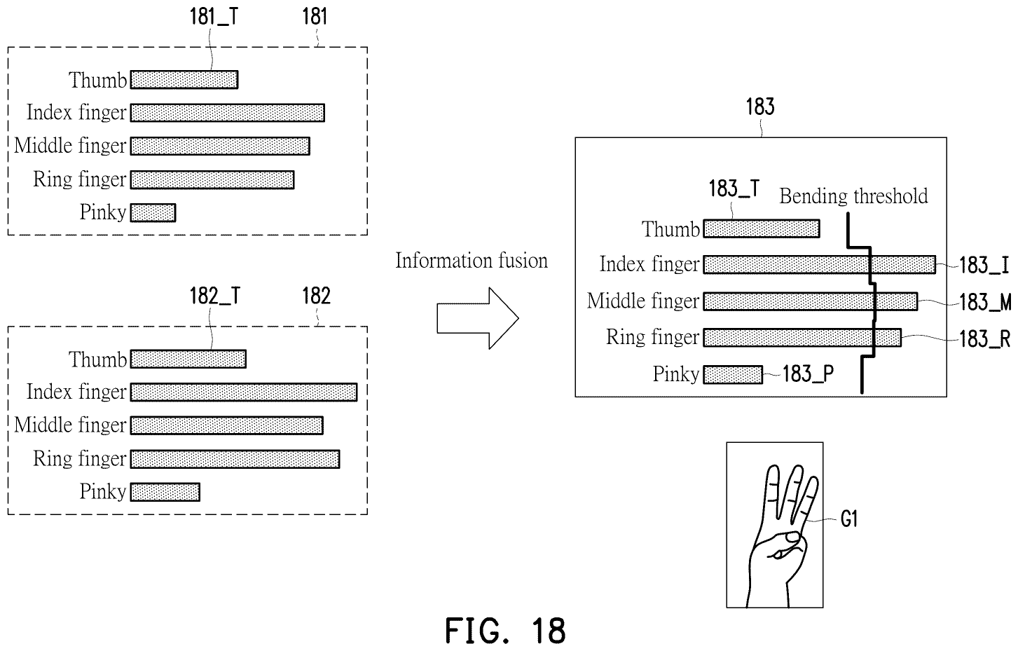

For example, FIG. 18 is a schematic diagram of determining target control gesture according to an exemplary embodiment of the disclosure. Referring to FIG. 18, the processing apparatus 130 may generate first finger bending information 181 for each finger based on the first image of the first image sensor 120_1, and generate second finger bending information 182 for each finger based on the second image of the second image sensor 120_2. The method of generating the first finger bending information 181 and the second finger bending information 182 may refer to the description of FIG. 17, for example. In FIG. 18, the finger bending information of each finger is represented by a horizontal bar graph, for example. The processing apparatus 130 may perform a weighted operation on the first finger bending information 181 and the second finger bending information 182 according to the fusion weight of the first image sensor 120_1 and the fusion weight of the second image sensor 120_2. Based on this, the processing apparatus 130 may obtain the fusion finger bending information 183 of multiple fingers.

For example, the processing apparatus 130 may perform a weighted operation on the first finger bending information 181_T of the thumb and the second finger bending information 182_T of the thumb to obtain the fusion finger bending information 183_T of the thumb. For example, assume that the fusion weight of first image sensor 120_1 is Wₚ and the fusion weight of second image sensor 120_2 is Wₛ. Assume that the first finger bending information 181_T of the thumb is the value A, and the second finger bending information 182_T of the thumb is the value B, then the fusion finger bending information 183_T of the thumb is equal to (value A×Wₚ+value B×Wₛ)/(Wp₊W_{S}).

In the embodiment of the disclosure, when the fusion finger bending information of a finger is greater than or equal to the corresponding bending threshold, it may mean that the finger is in a straightened state. When the fusion finger bending information of a finger is less than the corresponding bending threshold, it means that the finger is in a bent state.

As shown in FIG. 18, the processing apparatus 130 may compare the fusion finger bending information 183 of each finger with the corresponding bending threshold to determine whether each finger is in a straightened state or a bent state. When the fusion finger bending information 183_I of the index finger, the fusion finger bending information 183_M of the middle finger and the fusion finger bending information 183_R of the ring finger are all greater than the bending threshold, the processing apparatus 130 may determine that the index finger, middle finger and ring finger are in a straightened state. In addition, when the fusion finger bending information 183_T of the thumb and the fusion finger bending information 183_P of the little finger are less than the bending threshold, the processing apparatus 130 may determine that the thumb and little finger are in a bent state. Based on whether each finger is in a bent state or a straightened state, the processing apparatus 130 may determine the target control gesture G1 of the human hand object.

In step S1650, the processing apparatus 130 may determine the display content of the display 110 according to the target control gesture. For example, taking FIG. 1B as an example, after obtaining the target control gesture of the user U1 according to the process shown in FIG. 16, the target control gesture of the user U1 may be configured to determine the content of the display information vf1.

In some embodiments, in response to that the fusion finger bending information does not meet the candidate control gestures, the processing apparatus 130 may adjust the fusion finger bending information according to at least one variation amount until the fusion finger bending information meets a target controls gesture among the candidate control gestures. Based on this, it can reduce the probability of the processing device 130 determining a hand object as an undefined gesture, and it can also mitigate the impact of differences in finger lengths among different users on gesture determination. The variation amount may be set based on actual needs and actual application fields.

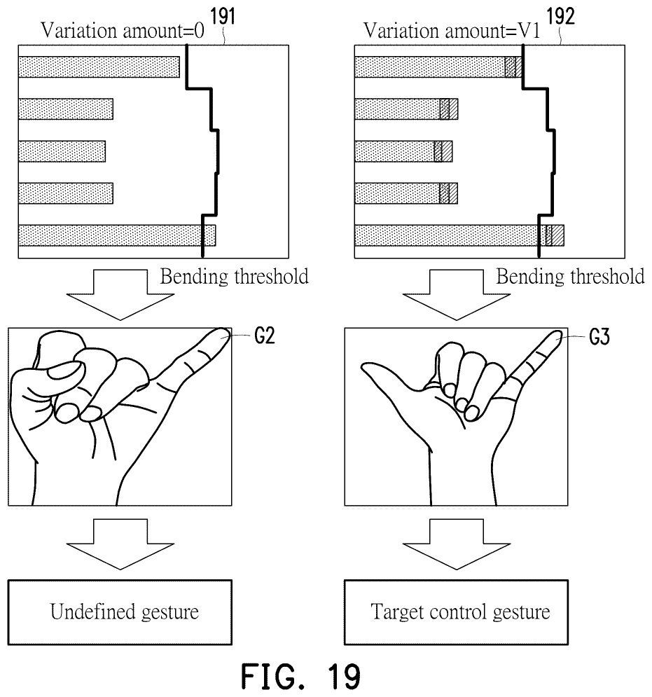

FIG. 19 is a schematic diagram of adjusting the fusion finger bending information according to the variation amount according to an exemplary embodiment of the disclosure. Referring to FIG. 19, the processing apparatus 130 may obtain the fusion finger bending information 191 of multiple fingers. The processing device 130 may determine gesture G2, where the pinky finger is extended while the other fingers are bent, based on the comparison between finger bending information 191 and the bend thresholds. However, gesture G2 is not a candidate control gesture, that is, gesture G2 is an undefined gesture.

In response to the fact that the fusion finger bending information 191 does not meet the candidate control gestures, the processing apparatus 130 may adjust the fusion finger bending information 191 according to the variation amount VI to generate the fusion finger bending information 192. The fusion finger bending information 191 of each finger may be added to or subtracted from the variation amount VI to obtain the adjusted fusion finger bending information 192. The processing apparatus 130 may determine the gesture G3 in which the thumb and pinky finger are straightened but the other fingers are bent based on the comparison result of the fusion finger bending information 192 and the bending threshold. Based on the gesture G3 being one of the candidate control gestures, the processing apparatus 130 may determine the gesture G3 as the target control gesture, and determine the display content of the display 110 based on the gesture G3. It should be noted that, assuming that the gesture G3 is not one of the candidate control gestures, the processing apparatus 130 may adjust and fusion finger bending information 192 according to a larger variation amount.

In some embodiments, in response to the fact that the fusion finger bending information does not match multiple candidate control gestures, the processing apparatus 130 may add the first variation amount to the fusion finger bending information of at least one finger and/or subtract the first variation amount from the fusion finger bending information of at least one finger. The variation amount is configured to obtain the adjusted fusion finger bending information. Afterwards, by determining whether the adjusted fusion finger bending information is greater than or equal to the bending threshold, the processing apparatus 130 may determine whether the adjusted fusion finger bending information meets any target control gesture among the candidate control gestures. If the fusion finger bending information after one-time adjustment still does not meet the candidate control gestures, the processing apparatus 130 may add and/or subtract the second variation amount to the fusion finger bending information corresponding to at least one finger to obtain a second adjusted fusion finger bending information. Afterwards, by determining whether the second adjusted fusion finger bending information is greater than or equal to the bending threshold, the processing apparatus 130 may determine whether the second adjusted fusion finger bending information meets the target control gesture among the candidate control gestures. The second variation amount may be greater than the first variation amount. For example, the second variation amount may be twice the first variation amount. That is, when the adjusted fusion finger bending information does not meet all candidate control gestures, the variation amount may continue to increase until the adjusted fusion finger bending information meets one of the candidate control gestures.

In some embodiments, the at least one variation amount (such as the first variation amount and the second variation amount) is greater than or equal to 0 and less than or equal to the maximum allowable variation. In some embodiments, when the variation amount reaches the maximum allowable variation and the fusion finger bending information adjusted multiple times still does not meet the candidate gesture, the processing apparatus 130 may output an undefined gesture determined based on the unadjusted fusion finger bending information. In some embodiments, the maximum allowable variation may be determined based on the numerical range of finger bending information.

For example, assume that the finger bending information of a user's thumb in a certain field is between 0.6 and 1.4. In other words, when the user's thumb is fully bent, the finger bending information of the thumb may be substantially equal to 0.6. When the user's thumb is fully extended, the thumb's finger bending information may be substantially equal to 1.4. In this case, the processing apparatus 130 may calculate the middle value 1 of this numerical range (i.e., 1=(1.4 0.6)/2) as the thumb bending threshold. That is to say, when the fusion finger bending information of the thumb calculated by the processor 130 is between 0.6 and 1, it may be determined that the thumb is bent. When the fusion finger bending information of the thumb calculated by the processor 130 is between 1 and 1.4, it may be determined that the thumb is straight. In addition, the processing apparatus 130 may determine the maximum allowable variation based on, for example, half of the numerical range corresponding to the bent state or the straightened state. For example, when the finger bending information of the thumb is between 0.6 and 1.4, the bending threshold is equal to 1 and the maximum allowable variation may be correspondingly set to 0.2 (that is, 0.2=(1-0.6)/2).

In addition, in some embodiments, the processing apparatus 130 may perform similar operations on other fingers of the user to obtain other bending thresholds and other maximum allowable variations corresponding to other fingers. Afterwards, the processing apparatus 130 may use the smallest of all maximum allowable variations corresponding to all fingers as the final maximum allowable variation. For example, assuming that the maximum allowable variations corresponding to the five fingers are 0.2, 0.4, 0.4, 0.4, and 0.4 respectively, the processing apparatus 130 may determine that the final maximum allowable variation is 0.2.

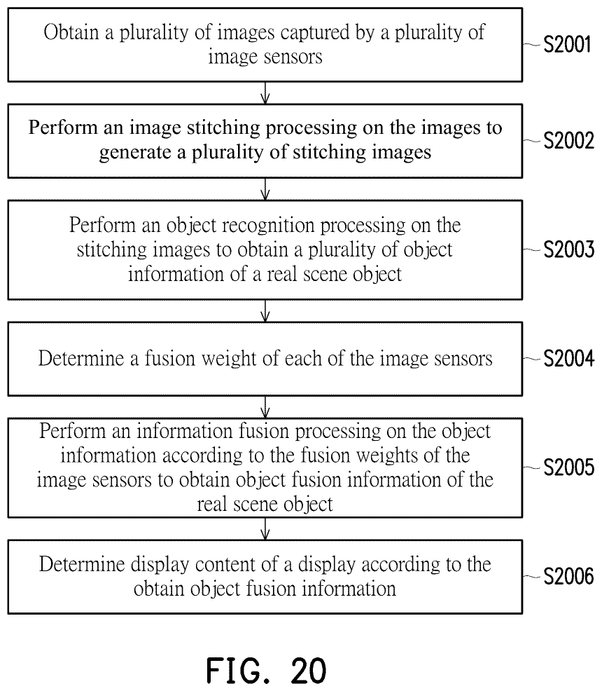

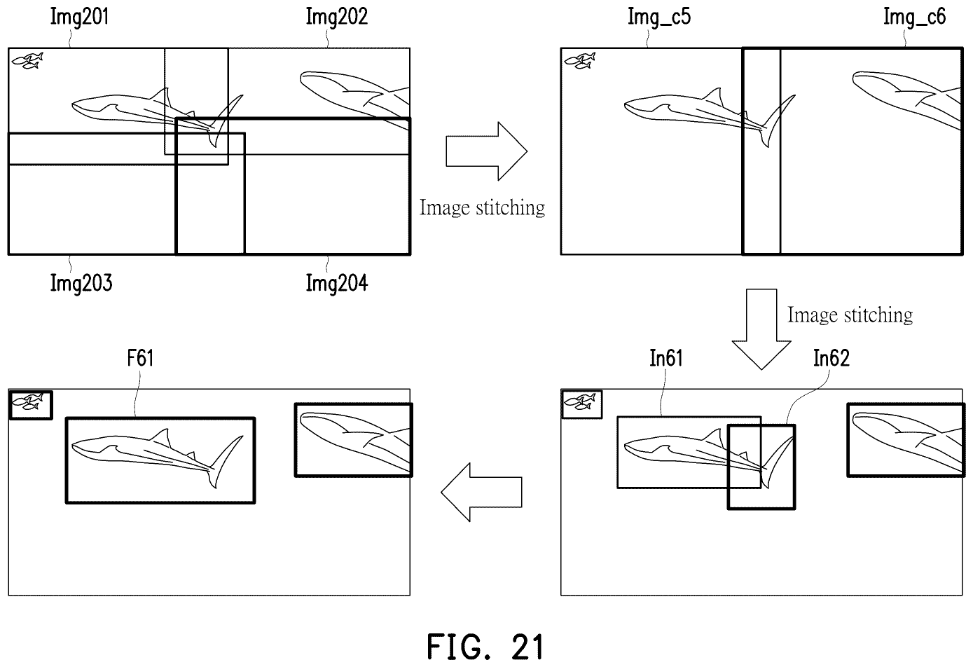

FIG. 20 is a flowchart of a multi-sensor coordination method according to an exemplary embodiment of the disclosure. The method flow of FIG. 20 may be implemented by the information display system 100 of FIG. 1A. FIG. 21 is a schematic diagram of a multi-sensor coordination method according to an exemplary embodiment of the disclosure. Referring to FIG. 20 and FIG. 21 together.

In step S2001, the processing apparatus 130 may obtain images Img201 to Img204 captured by multiple image sensors 120_1 to 120_4. In step S2002, the processing apparatus 130 may perform image stitching processing on the images Img201 to Img204 to generate multiple stitching images Img_c5 and Img_c6. In this example, the processing apparatus 130 may first perform image stitching processing on the images of different parts of the image sensors to generate multiple stitching images.

In step S2003, the processing apparatus 130 may perform object recognition processing on multiple stitching images Img_c5 and Img_c6, and may obtain a plurality of object information In61 and In62 of a real scene object. In step S2004, the processing apparatus 130 may determine the fusion weight of each image sensor 120_1˜120_4. Relevant implementation methods for determining the fusion weight of each image sensor 120_1 to 120_4 may be described with reference to the foregoing embodiments. In step S2005, the processing apparatus 130 may perform information fusion processing on a plurality of object information In61 and In62 based on the fusion weights of at least part of the image sensors 120_1 to 120_4, and may obtain one object fusion information F61 of the real scene object. In step S2006, the processing apparatus 130 may determine the display content of the display 110 based on the object fusion information.

It should be noted that, the implementation example in FIG. 21 is to perform image stitching on the left images Img201 and Img203 and the right images Img202 and Img204 respectively to generate stitching images Img_c5 and Img_c6, and then execute subsequent steps. However, in other embodiments, the processing apparatus 130 may first perform image stitching on the upper side images Img201 and Img202 and the lower side images Img203 and Img204 to generate a stitching image, and then perform subsequent steps.

The multi-sensor coordination method, processing apparatus and information display system proposed in the exemplary embodiments of the disclosure may perform information fusion on object information generated by multiple image sensors. Based on this, the disclosure may improve the stability of information display so that the displayed content may be displayed stably and smoothly, thereby improving the user's viewing experience.

Although the disclosure has been disclosed above in the form of exemplary embodiments, The is not intended to limit the disclosure. Anyone with ordinary knowledge in the relevant technical field may make changes and modifications without departing from the spirit and scope of the disclosure. Therefore, the protection scope of the disclosure shall be determined by the appended patent application scope and its equivalent scope.

What is claimed is:

1. A multi-sensor coordination method, adapted to an information display system comprising a display and a plurality of image sensors, and comprising:
obtaining a plurality of images captured by the image sensors;
performing an object recognition processing on the images or a stitching image of the images to obtain a plurality of object information of a real scene object;
determining a fusion weight of each of the image sensors;
performing an information fusion processing on the plurality of object information according to the fusion weight of each of the image sensors to obtain an object fusion information of the real scene object; and
determining display content of a display according to the object fusion information.

2. The multi-sensor coordination method according to claim 1, further comprising:
obtaining a capture angle of each of the image sensors; and
performing an image stitching processing according to the capture angle of each of the image sensors to generate the stitching image.

3. The multi-sensor coordination method according to claim 2, wherein the image sensors comprise a first image sensor and a second image sensor, the images comprise a first image of the first image sensor and a second image of the second image sensor, and the step of performing the image stitching processing according to the capture angle of each of the image sensors to generate the stitching image comprises:
performing an image geometric correction processing on the first image or the second image according to the capture angle of the first image sensor and the capture angle of the second image sensor to generate at least one corrected image; and
performed the image stitching processing according to the at least one corrected image to generate the stitching image.

4. The multi-sensor coordination method according to claim 1, wherein the image sensors comprise a first image sensor and a second image sensor, the images comprise a first image of the first image sensor and a second image of the second image sensor, and the plurality of object information of the real scene object comprise a first spatial coordinate associated with the first image sensor and a second spatial coordinate associated with the second image sensor,
wherein the step of performing the information fusion processing on the plurality of object information according to the fusion weight of each of the image sensors to obtain the object fusion information of the real scene object comprises:
performing a weighted operation on the first spatial coordinate and the second spatial coordinate according to the fusion weight of the first image sensor and the fusion weight of the second image sensor to obtain a fusion spatial coordinate of the real scene object.

5. The multi-sensor coordination method according to claim 1, wherein the image sensors comprise a first image sensor and a second image sensor, the images comprise a first image of the first image sensor and a second image of the second image sensor, and the step of performing the object recognition processing on the images or the stitching image of the images to obtain the plurality of object information of the real scene object comprises:
performing the object recognition processing on the first image of the first image sensor and the second image of the second image sensor respectively to obtain a first region of interest (ROI) and a second region of interest; and
performing a coordinate conversion on the first ROI of the first image and the second ROI of the second image respectively to obtain a first spatial coordinate of the first ROI and a second spatial coordinate of the second ROI.

6. The multi-sensor coordination method according to claim 5, wherein the step of performing the object recognition processing on the images or the stitching image of the images to obtain the plurality of object information of the real scene object further comprises:
obtaining an area intersection information of the first ROI and the second ROI according to the first spatial coordinate of the first ROI and the second spatial coordinate of the second ROI; and
determining that the first spatial coordinate and the second spatial coordinate correspond to the real scene object based on the area intersection information, an object classification category of the first ROI, and an object classification category of the second ROI.

7. The multi-sensor coordination method according to claim 6, wherein the object recognition processing is performed by using a convolutional neural network model, and the step of performing the object recognition processing on the images or the stitching image of the images to obtain the plurality of object information of the real scene object comprises:
performing a weighted operation on a plurality of classification confidence values of the first ROI and a plurality of classification confidence values of the second ROI according to the fusion weight of the first image sensor and the fusion weight of the second image sensor, to obtain a plurality of fusion classification confidence values; and
determining a target classification category of the real scene object according to the highest one among the fusion classification confidence values.

8. The multi-sensor coordination method according to claim 1, wherein the image sensors comprise a first image sensor and a second image sensor, the images comprise a first image of the first image sensor and a second image of the second image sensor, the real scene object is a face object, and the plurality of object information of the real scene object comprise a first facial orientation angle of a first face ROI sensed by the first image sensor and a second facial orientation angle of a second face ROI sensed by the second image sensor,
wherein the step of performing the information fusion processing on the plurality of object information according to the fusion weight of each of the image sensors to obtain the object fusion information of the real scene object comprises:
performing a weighted operation on the first facial orientation angle of the first face ROI and the second facial orientation angle of the second face ROI according to the fusion weight of the first image sensor and the fusion weight of the second image sensor, to obtain a fusion facial orientation angle of the face object.

9. The multi-sensor coordination method according to claim 1, wherein the image sensors comprise a first image sensor and a second image sensor, the images comprise a first image of the first image sensor and a second image of the second image sensor, and the step of determining the fusion weight of each of the image sensors comprises:
obtaining a first image object position of the first ROI in the first image and a second image object position of the second ROI in the second image;
determining the fusion weight of the first image sensor according to the first image object position; and
determining the fusion weight of the second image sensor according to the second image object position.

10. The multi-sensor coordination method according to claim 9, wherein the step of determining the fusion weight of the first image sensor according to the first image object position comprises:
obtaining a target distance between the first image object position and an image boundary of the first image; and
determining the fusion weight of the first image sensor according to the target distance.

11. The multi-sensor coordination method according to claim 10, wherein the step of obtaining the target distance between the first image object position and the image boundary of the first image comprises:
calculating a first reference distance between the first image object position and a first reference image boundary of the first image;
calculating a second reference distance between the first image object position and a second reference image boundary of the first image, wherein the first reference image boundary is parallel to the second reference image boundary; and
determining the smaller one between the first reference distance and the second reference distance as the target distance.

12. The multi-sensor coordination method according to claim 11, wherein the step of obtaining the target distance between the first image object position and the image boundary of the first image further comprises:
determining that the first reference image boundary and the second reference image boundary are vertical image boundaries or horizontal image boundaries according to arrangement of the first image sensor and the second image sensor.

13. The multi-sensor coordination method according to claim 10, wherein the fusion weight of the first image sensor is the N^{th} power of the target distance, and N is greater than 0.

14. The multi-sensor coordination method according to claim 1, wherein the image sensors comprise a first image sensor and a second image sensor, and the step of determining the fusion weight of each of the plurality of image sensors comprises:
obtaining a first object detection rate of the first image sensor within a preset period;
obtaining a second object detection rate of the second image sensor within the preset period; and
determining the fusion weight of the first image sensor and the fusion weight of the second image sensor according to the first object detection rate and the second object detection rate.

15. The multi-sensor coordination method according to claim 1, wherein the image sensors comprise a first image sensor and a second image sensor, the images comprise a first image of the first image sensor and a second image of the second image sensor, the real scene object is a hand object, and the plurality of object information of the real scene object comprise a first finger bending information sensed by the first image sensor and a second finger bending information sensed by the second image sensor,
wherein the step of performing the information fusion processing on the plurality of object information according to the fusion weight of each of the image sensors to obtain the object fusion information of the real scene object comprises:
performing a weighted operation on the first finger bending information and the second finger bending information according to the fusion weight of the first image sensor and the fusion weight of the second image sensor, to obtain a fusion finger bending information of the hand object
determining a target control gesture according to the fusion finger bending information of the hand object and a plurality of bending thresholds corresponding to a plurality of fingers.

16. The multi-sensor coordination method according to claim 15, wherein the step of determining the display content of the display based on the object fusion information comprises:
determining the display content of the display according to the target control gesture.

17. The multi-sensor coordination method according to claim 16, wherein determining the target control gesture according to the fusion finger bending information of the hand object and the bending thresholds corresponding to the fingers comprises:
adjusting the fusion finger bending information by using at least one variation amount until the fusion finger bending information meets the target control gesture among a plurality of candidate gestures in response to the fusion finger bending information does not meet the plurality of candidate gestures.

18. The multi-sensor coordination method according to claim 15, wherein the step of performing the object recognition processing on the images or the stitching image of the images to obtain the plurality of object information of the real scene object comprises:
performing the object recognition processing on the first image to obtain a plurality of first palm feature points corresponding to the hand object in the first image;
performing the object recognition processing on the second image to obtain a plurality of second palm feature points corresponding to the hand object in the second image; and
calculating the first finger bending information of each finger according to the first palm feature points, and calculating the second finger bending information of each finger according to the second palm feature points.

19. An information display system, comprising:
a display;
a plurality of image sensors; and
a processing apparatus, connecting to the display and the image sensors, and configured to:
obtain a plurality of images captured by the image sensors;
perform an object recognition processing on the images or a stitching image of the images to obtain a plurality of object information of a real scene object;
determine a fusion weight of each of the image sensors;
perform an information fusion processing on the plurality of object information according to the fusion weight of each of the image sensors to obtain an object fusion information of the real scene object; and
determine display content of a display according to the object fusion information.

20. A processing apparatus, comprising:
a memory configured to store data; and
a processor connected to the memory and configured to:
obtain a plurality of images captured by a plurality of image sensors;
perform an object recognition processing on the images or a stitching image of the images to obtain a plurality of object information of a real scene object;
determine a fusion weight of each of the image sensors;
perform an information fusion processing on the plurality of object information according to the fusion weight of each of the image sensors to obtain an object fusion information of the real scene object; and
determine display content of a display according to the object fusion information.
